(19) United States
(12) Patent Application Publication
(10) Pub. No.: US 2026/0239374 A1
(43) Pub. Date: Aug. 13, 2026

(54) PDSCH DEFAULT BEAM DETERMINATION BASED ON A UTCI SELECTOR IN A DL-DCI

(71) Applicant: InterDigital Patent Holdings, Inc., Wilmington, DE (US)

(72) Inventors: Jonghyun PARK, Syosset, NY (US); Afshin HAGHIGHAT, lle-Bizard (CA); Moon IL LEE, Melville, NY (US); Loic CANONNE-VELASQUEZ, Dorval (CA); Virgil COMSA, Montreal (CA)

(73) Assignee: InterDigital Patent Holdings, Inc., Wilmington, DE (US)

(21) Appl. No.: 19/156,121

(22) PCT Filed: Feb. 12, 2024
(86) PCT No.: PCT/US2024/015353

§ 371 Date: Aug. 13, 2025

Related U.S. Application Data
(60) Provisional application No. 63/445,612, filed on Feb. 14, 2023.

(51) Int. Cl. H04W 72/232; H04L 5/00

(52) U.S. Cl. CPC H04W 72/232; H04L 5/0094

(57) ABSTRACT

One or more techniques are disclosed herein that provide a method/device/system for addressing unified TCI (UTCI) management and associated technologies. These one or more techniques may generally provide innovation and or improvements to the field of wireless communications. In an example, there may be a process for determining a TCI to use for transmission/reception. There may be a default TCI, and there may be a determination of when to use the default TCI and what the default TCI is.

### CROSS-REFERENCE TO RELATED APPLICATIONS

This application claims the benefit of U.S. Provisional Application No. 63/445,612, filed Feb. 14, 2023, the contents of which are incorporated herein by reference.

### BACKGROUND

In wireless telecommunications, a device may have the ability to send a transmission using one or more beams. Accordingly, there is a need to efficiently and manage which beam is used such that a sending and receiving device can operate and communicate in an efficient manner.

### SUMMARY

One or more techniques are disclosed herein that provide a method/device/system for addressing unified TCI (UTCI) management and associated technologies. These one or more techniques may generally provide innovation and or improvements to the field of wireless communications. In an example, there may be a process for determining a TCI to use for transmission/reception. There may be a default TCI, and there may be a determination of when to use the default TCI and what the default TCI is.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a DCI field (e.g., TCI field) of a DCI for unified TCI-state indications;

FIG. 3 illustrates an example of UTCI update timeline and UTCI selection for a data reception;

FIG. 4 illustrates an example of UTCI update timeline and UTCI selection for UL transmission;

FIG. 5 illustrates an example of UTCI deactivation based on an UTCI selection;

FIG. 6 illustrates an example method according to one or more techniques described herein;

FIG. 7 illustrates an example of UTCI update timeline and UTCI selection; and

FIG. 8 illustrates an example method according to one or more techniques described herein.

### DETAILED DESCRIPTION

One or more techniques are disclosed herein that provide a method/device/system for addressing unified TCI (UTCI) management and associated technologies. These one or more techniques may generally provide innovation and or improvements to the field of wireless communications, as well as address specific issues, such as (but not limited to): How to determine a PDSCH (default) beam when a UTCI-selector indicates at least one of one or more UTCIs in a DL-DCI and a scheduling and/or time offset (k0) is less than a threshold (e.g., timeDurationForQCL) as a part of WTRU capability parameters; ow to determine a UL beam, at least with respect to application timeline, when a UTCI-selector in a UL-DCI indicates at least one of one or more UTCIs indicated by a DL-DCI? How to map or associate between a WTRU-panel and a UTCI, selected by a UTCI-selector, of indicated one or more UTCIs applicable for multiple channels and/or signals? How to maintain QCL tracking behaviors on which one or more UTCIs indicated by a DL-DCI when a UTCI-selector indicates a subset of the one or more UTCIs? How to determine a DL or UL beam when a DCI indicating a cross-carrier scheduling?

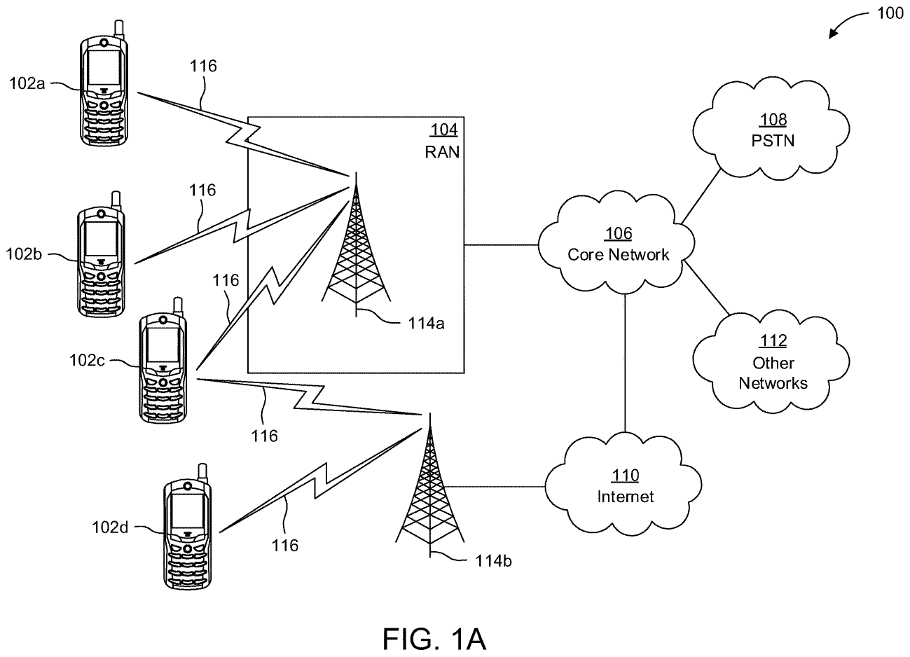

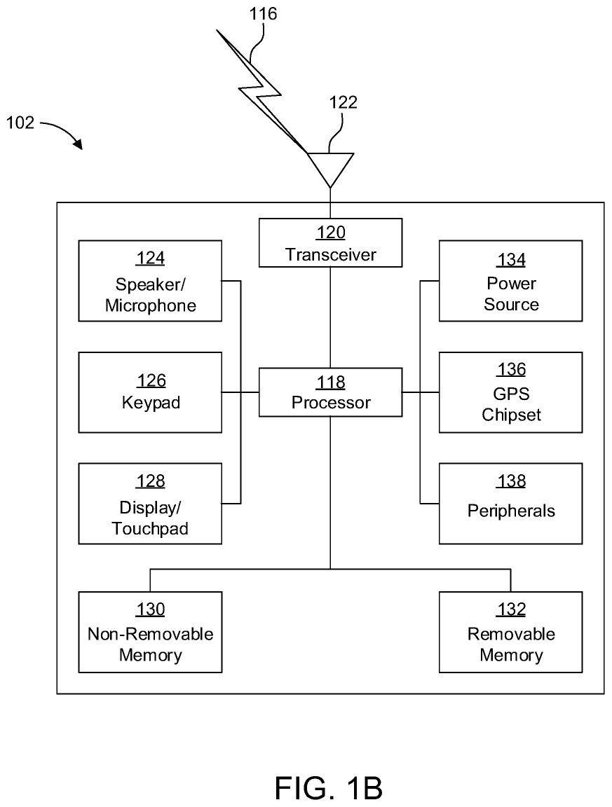

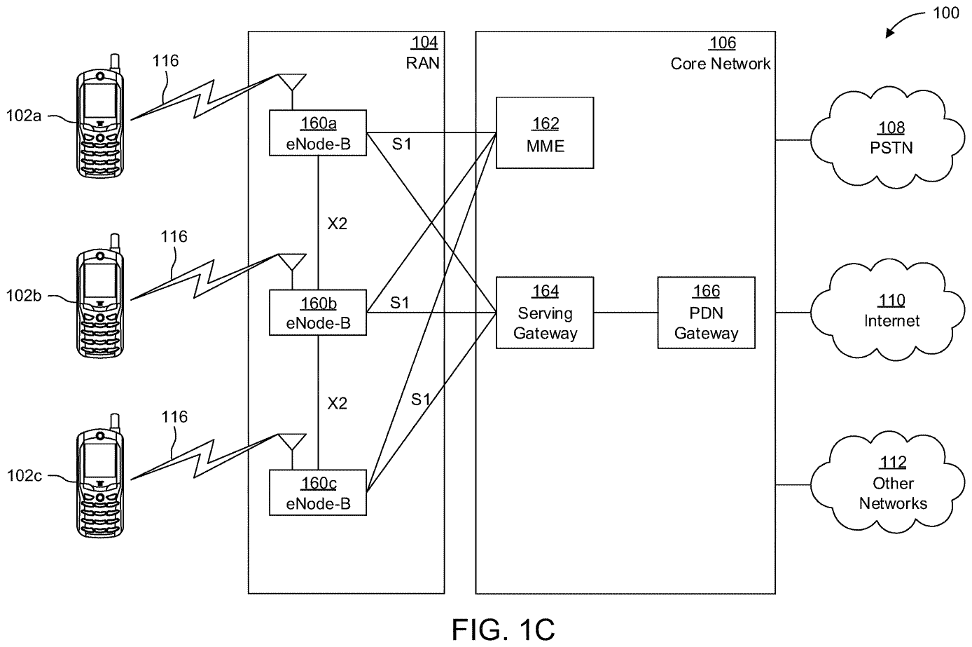

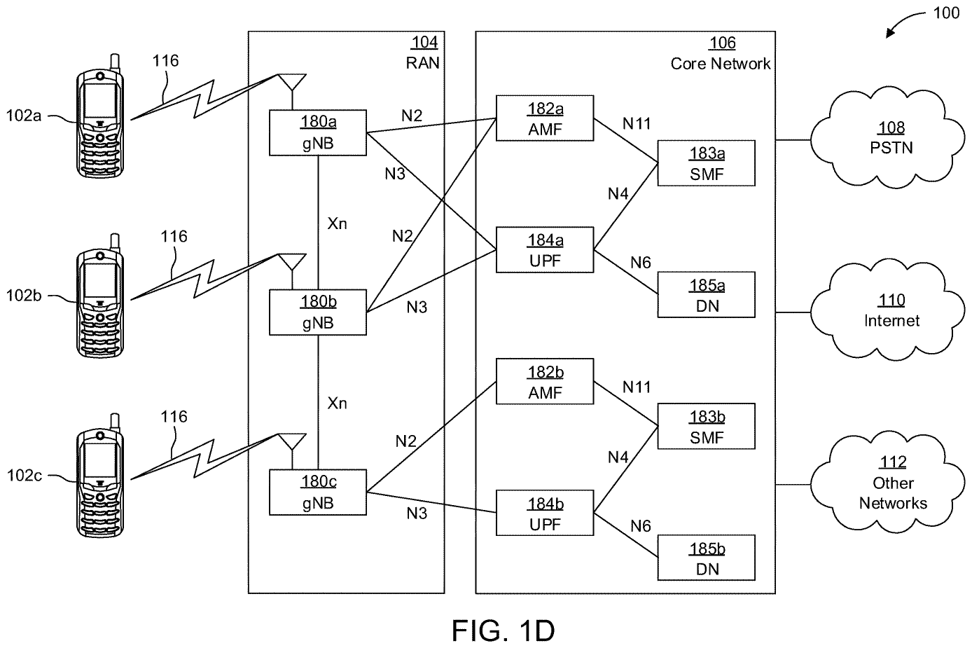

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A unified transmission configuration indication (TCI) framework may support one unified TCI (e.g., joint or a pair of separate DL/UL), which may be indicated or maintained at the WTRU, to be applicable for more than one channel or signal type (e.g., both of control and data channels) simultaneously, which is different from an individual beam control per channel or signal as may have been used in legacy cases.

In some cases, there may be multi-TRP (MTRP) support, where multi-downlink control information (DCI) based MTRP (MDCI-MTRP) may be based on CORESETPoolIndex=0 or 1, to support enhanced mobile broadband (eMBB). In some cases, a single-DCI based MTRP (SDCI-MTRP) may be based on associating up to two TCI-states for a codepoint of TCI field in a DCI, for repeated transmissions across TRPs, for reliability enhancements.

In some cases (e.g., MIMO) there may be a unified TCI framework for indicating multiple DL and UL TCI states focusing on multi-TRP use scenario.

A WTRU may transmit or receive a physical channel or reference signal according to at least one spatial domain filter. The term “beam” may be used herein to refer to a spatial domain filter.

The WTRU may transmit a physical channel or signal using the same spatial domain filter as the spatial domain filter used for receiving an RS (e.g., CSI-RS) or a Synchronization Signal Block (SSB). The WTRU transmission may be referred to as a “target”, and the received RS or SSB may be referred to as a “reference” or “source”. In such a case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such a case, the WTRU may be said to transmit the first (target) physical channel or signal according to a spatial relation with a reference to the second (reference) physical channel or signal. Note, the reference (second) may exist prior in time compared to the target (first), since the reference is used for the target.

A spatial relation may be implicit, configured by RRC, or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”. Said another way, a transmission configuration indicator (TCI) state(s) may provide an association between a reference signal(s) and a source signal(s) such that a device can perform sending/receiving of a target signal(s). An indication of one or more TCIs may be transmitted in a control channel, such as a PDCCH. An indication of one or more TCIs may be transmitted in a downlink control channel information (DCI) message. A DCI may provide an indication (e.g., TCI) explicitly (e.g., field, RNTI scramble, etc.) or implicitly (e.g., format, size, etc.) as further disclosed herein.

A unified TCI (e.g., a common TCI, a common beam, a common RS, etc.) may refer to a beam/RS to be (e.g., simultaneously) used for multiple physical channels/signals. The term “TCI” may at least comprise a TCI state that includes at least one source RS to provide a reference (e.g., WTRU assumption) for determining QCL and/or spatial filter, where the QCL and/or spatial filter may be used for receiving/sending of a target signal(s).

In an example, a WTRU may receive (e.g., from a base station) an indication of a first unified TCI to be used/applied for both a physical downlink control channel (PDCCH) and a physical downlink shared channel (PDSCH) (e.g., and a downlink RS). The source reference signal(s) in the first unified TCI may provide common QCL information at least for WTRU-dedicated reception on the PDSCH and all or a subset of CORESETs in a CC. In an example, a WTRU may receive (e.g., from a base station) an indication of a second unified TCI to be used/applied for both a physical uplink control channel (PUCCH) and a physical uplink shared channel (PUSCH) (e.g., and an uplink RS). The source reference signal(s) in the second unified TCI may provide a reference for determining common UL TX spatial filter(s) at least for dynamic-grant/configured-grant based PUSCH and all or a subset of dedicated PUCCH resources in a CC.

The WTRU may be configured with a first mode for unified TCI (e.g., SeparateDLULTCI mode) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station) an indication of a second unified TCI to be used/applied commonly for a PDCCH, a PDSCH, a PUCCH, and a PUSCH (e.g., and also a DL RS and/or a UL RS).

The WTRU may be configured with a second mode for unified TCI (e.g., JointTCI mode) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance applicable to this transmission or reception, then determining a TCI state corresponding to the Unified TCI state instance. A transmission may consist of at least PUCCH, PUSCH, SRS. A reception may consist of at least PDCCH, PDSCH, CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A Unified TCI state instance may be equivalent or identified to a control resource set (CORESET) Pool identity (e.g., CORESETPoolIndex, a TRP indicator, and/or the like).

As disclosed herein, a unified TCI may be interchangeable with one or more of unified TCI-states, unified TCI instance, TCI, and/or TCI-state.

As disclosed herein, a transmission and reception point (TRP) may be interchangeably used with one or more of TP (transmission point), RP (reception point), RRH (radio remote head), DA (distributed antenna), BS (base station), a sector (of a BS), a network node, a relay device (e.g., WTRU), and a cell (e.g., a geographical cell area served by a BS); further, this interchangeability may apply in reverse (e.g., reference to a base station may my interchangeable with a TRP, etc.). Hereafter, Multi-TRP may be interchangeably used with one or more of TRP, M-TRP, and multiple TRPs. For example, if some piece of information is indicated from a base station, the term base station could be substituted for gNB, TRP, MTRP, and/or the like.

A WTRU may be configured with, or may receive configuration of, one or more TRPs to which the WTRU may transmit and/or from which the WTRU may receive. The WTRU may be configured with one or more TRPs for one or more cells. A cell may be a serving cell and/or a secondary cell.

A WTRU may be configured with at least one RS for the purpose of channel measurement. This RS may be denoted as a Channel Measurement Resource (CMR) and may comprise a CSI-RS, SSB, or other downlink RS transmitted from the TRP to a WTRU. A CMR may be configured or associated with a TCI state. A WTRU may be configured with a CMR group where CMRs transmitted from the same TRP may be configured. Each group may be identified by a CMR group index (e.g., group 1). A WTRU may be configured with one CMR group per TRP, and the WTRU may receive a linkage between one CMR group index and another CMR group index, or between one RS index from one CMR group and another RS index from another group.

A WTRU may be configured with, or receive configuration of, one or more pathloss (PL) reference groups (e.g., sets) and/or one or more SRS groups, SRS resource indicator (SRI), or SRS resource sets.

A PL reference group may correspond to or may be associated with a TRP. A PL reference group may include, identify, correspond to or be associated with one or more TCI states, SRIs, reference signal sets (e.g. CSI-RS set, SRI sets), CORESET index, and or reference signals (e.g. CSI-RS, SSB).

A WTRU may receive a configuration (e.g., any configuration described herein). The configuration may be received from a base station and/or a TRP. For example, the WTRU may receive a configuration of one or more TRPs, one or more PL reference groups and/or one or more SRI sets. A WTRU may implicitly determine an association between a RS set/group and a TRP. For example, if the WTRU is configured with two SRS resource sets, then the WTRU may determine to transmit to TRP1 with SRS in the first resource set, and to TRP2 with SRS in the second resource set. The configuration may be via RRC signaling.

As described herein, TRP, PL reference group, SRI group, and SRI set may be used interchangeably. The terms set and group may be used interchangeably herein.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g., cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A described herein, a property of a grant or assignment may comprise of at least one of the following: a frequency allocation; an aspect of time allocation, such as a duration; a priority; modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by MAC or by RRC for the scheduling the grant or assignment.

As described herein, an indication by DCI may comprise of at least one of the following: an explicit indication by a DCI field or by RNTI used to mask CRC of the PDCCH; and/or, an implicit indication by a property such as DCI format, DCI size, CORESET or search space, Aggregation Level, first resource element of the received DCI (e.g., index of first Control Channel Element), where the mapping between the property and the value may be signaled by RRC or MAC.

As described herein, a signal may be interchangeably used with one or more of following: sounding reference signal (SRS); channel state information-reference signal (CSI-RS); demodulation reference signal (DM-RS); phase tracking reference signal (PT-RS); synchronization signal block (SSB); message; transmission; and/or the like.

As described herein, a channel may be interchangeably used with one or more of following: physical downlink control channel (PDCCH); physical downlink shared channel (PDSCH); physical uplink control channel (PUCCH); physical uplink shared channel (PUSCH); and/or, physical random access channel (PRACH).

As described herein, downlink reception may be used interchangeably with Rx occasion, PDCCH, PDSCH, and SSB reception.

As described herein, uplink transmission may be used interchangeably with Tx occasion, PUCCH, PUSCH, PRACH, and SRS transmission.

As described herein, RS may be interchangeably used with one or more of RS resource, RS resource set, RS port and RS port group.

As described herein, RS may be interchangeably used with one or more of SSB, CSI-RS, SRS and DM-RS.

As described herein, time instance may be interchangeably used with slot, symbol, and subframe.

As described herein, UTCI may be interchangeably used with TCI, UTCI state, and TCI state.

A WTRU may be configured with a plurality of transmission configuration indicator (TCI) states, such as unified TCI (UTCI) state(s), each applicable for one or multiple channel(s)/signal(s). The one or multiple channel(s)/signal(s) may be sent in a configuration message to the WTRU, or pre-determined or defined, (e.g., in a form of a list) by a higher-layer signaling (e.g., RRC and/or MAC-CE) that may comprise one or more of the following (e.g., as a combination): one or more CORESETs; one or more PDCCH candidates; one or more search spaces; one or more PDSCHs (e.g., PDSCH occasions/configurations/instances, etc.); one or more RSs (e.g., CSI-RSs, DMRSs, SSB indexes, PRSs, PTRSs, and/or SRSs); one or more PUSCHs (e.g., PUSCH occasions/configurations/instances, etc.); one or more PUCCH resources (e.g., PUCCH resource sets/groups); and/or, one or more PRACH occasions/resources/RSs.

The plurality of TCI states may be configured via an RRC signaling (e.g., and/or via a MAC-CE signaling, indication or activation). The WTRU may receive (e.g., via the MAC-CE or a separate signaling) an information content comprising mapping between one or more codepoints of a DCI field (e.g., TCI field, and/or TCI selection field) and at least one TCI state of the plurality of TCI states. The WTRU may receive a DCI message comprising the DCI field. The WTRU may be indicated one or more TCI states, of the plurality of TCI states, mapped to a codepoint of the one or more codepoints of the DCI field, where each of the one or more TCI states is applicable after a time duration determined based on a beam application time (BAT) parameter; said another way, because there may be a BAT (e.g., configured parameter), a WTRU may need to wait until a BAT has passed in order to apply one or more TCI states (e.g., where the one or more TCI states are known prior to the BAT passing); it may follow further that, if a BAT has not passed then one or more TCI states may not be applied (e.g. yet, or ever, until at least a BAT has passed and/or some other indication/trigger for using the one or more TCI states has occurred as disclosed herein).

In some cases, there may be a DCI field (e.g., TCI field) of a DCI for unified TCI-state indications. A WTRU may receive the mapping between a codepoint (e.g., of the DCI field) and one or more TCI states, as illustrated in the figure (e.g., via a MAC-CE signaling). For example, Codepoint 2 is mapped to {UTCI3, UTCI7}, where the WTRU may apply at least one of {UTCI3, UTCI7} to the multiple channel(s)/signal(s) (e.g., based on a list of the multiple channel(s)/signal(s) configurable by a higher-layer signaling from a base station). In an example, the list of the multiple channel(s)/signal(s) may be given per UTCI instance, where the UTCI instance may correspond to each column of the mapping table, as illustrated in the figure, between a codepoint and the one or more TCI states.

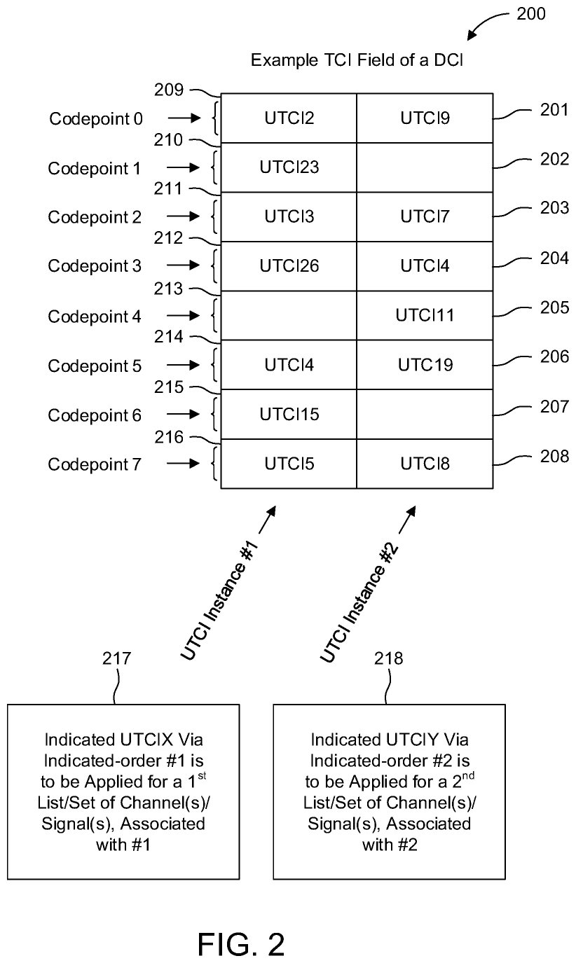

FIG. 2 illustrates an example of a DCI field (e.g., TCI field) of a DCI for unified TCI-state indications. A WTRU may receive a control transmission over a control channel; in the control transmission, there may be a downlink control information (DCI) message (e.g., having a specific format, size, number and/or types of fields, purpose, and/or the like); the DCI message may comprise a mapping between a codepoint (e.g., of the DCI field) and one or more TCI states, as shown at 200 (e.g., via a MAC-CE signaling). Generally, a DCI may comprise, amongst other indications, a table/list/field that contains one or more columns and one or more rows. As shown in the figure, there may be a correlation of codepoint (e.g., number) with a row, where in each row there may be a set (e.g., ordered set) of UTCI (e.g., each UTCI illustrated as 201-216). For example, codepoint 0 is mapped to a set of UTCI, {UTCI2 and UTCI9}, where UTCI2 is the first UTCI of the set and UTCI9 is the second UTCI of the set. For example, Codepoint 2 is mapped to {UTCI3, UTCI7}, where the WTRU may apply at least one of {UTCI3, UTCI7} to the one or multiple channel(s)/signal(s) (e.g., based on a set/list of the one or multiple channel(s)/signal(s) configurable by a higher-layer signaling from a base station). In an example, the set/list of the one or multiple channel(s)/signal(s) may be given per UTCI instance (e.g., as shown at 217 and 218), where the UTCI instance may correspond to each column of the mapping table, as illustrated in the figure, between a codepoint and the one or more TCI states. From this figure, it may be understood that a WTRU can support a variety of number of UTCI, depending on the codepoint; for example, a WTRU may support one UTCI; a WTRU may support two UTCI. From this figure, it may be understood that a WTRU may support two UTCIs to be maintained, depending on the codepoint; for example, when codepoint 1 is indicated the WTRU may update the first UTCI to be UTCI23 while the WTRU may not update the second UTCI and may continue to use the current second UTCI (e.g., where the example TCI field may be used as “UTCI (beam) update”).

In some cases, a device may determine a PDSCH default beam based on a UTCI selector in a DL-DCI.

In one case, a WTRU may receive configuration of a plurality of transmission configuration indicator (TCI) states, (e.g., unified TCI (UTCI) states, each applicable for one or multiple channel(s) or signal(s)). The one or multiple channel(s) or signal(s), associated with a TCI state, may be sent in a configuration message to the WTRU (or pre-determined or defined) (e.g., in a form of a list) by a higher-layer signaling (e.g., RRC and/or MAC-CE).

The WTRU may receive DCI1, where the DCI1 indicates {TCI1, TCI2} via a first field (e.g., TCI field) of the DCI1 and schedules PDSCH1. The WTRU may transmit a first ACK in response to receiving (e.g., successfully receiving) DCI1 and/or PDSCH1.

The WTRU may receive (e.g., after transmitting the first ACK) DCI2 using at least one of {TCI1, TCI2}, where the DCI2 indicates {TCI3, TCI4} via the first field (e.g., TCI field) of the DCI2 and schedules PDSCH2. The DCI2 further indicates a selector via a second field (e.g., TCI-selection field), where the selector indicates one of the TCI states {TCI1, TCI2} that were indicated by the DCI1. In some instances, a TCI selection field in a DCI may indicate a value (e.g., Codepoint ‘11’) that may correspond to applying both TCIs, as explained further herein.

The WTRU may receive PDSCH2 using a TCI state determined based on at least one of: the selector indicated by DCI2, a time offset k0 between the transmission (or reception) of DCI2 and the transmission (or reception) of PDSCH2, a default TCI state, and/or a previously indicated TCI state. In an example the value of k0 is indicated in DCI2. In an example, if the value of k0 is less than a threshold, the WTRU uses a default TCI state, TCI X, to receive PDSCH2. In an example, if the value of k0 is greater than the threshold, the WTRU uses the TCI state indicated by the selector to receive PDSCH2. In an example, the threshold is a part of WTRU capability parameters (e.g., that are reported to the base station).

The WTRU may transmit a second ACK in response to receiving (e.g., successfully receiving) DCI2 and/or PDSCH2.

In one instance, the WTRU may use TCI3 or TCI4 for receiving another PDSCH or PDCCH after receiving PDSCH2.

In an example, the default TCI X may be, or may be determined to be based on, at least one of following: a default UTCI state, which may be TCI Y, associated with a CORESET with a pre-defined or pre-configured CORESET index, such as UTCI(s) associated with a CORESET with a lowest (or highest) ID; and/or, a previously selected TCI state (e.g., a most recently selected TCI state) by a TCI-selection field in a DCI3 (e.g., scheduling a PDSCH3) received prior to DCI2 that satisfies the condition that the WTRU sent an ACK for DCI3 or PDSCH3 (e.g., indicating successful reception of DCI3 or PDSCH3) at least a time duration (e.g., configured time duration) before the transmission (or reception) of DCI2. In one instance, the time duration may be determined based on a beam application time (BAT) parameter configured from the base station and/or reported by the WTRU as a part of WTRU capability parameters.

In one case, a WTRU may receive configuration of a plurality of transmission configuration indicator (TCI) states (e.g., unified TCI (UTCI) states) each applicable for multiple channel(s) or signal(s). The multiple channel(s) or signal(s), associated with a TCI state, may be sent in a configuration message to the WTRU (or pre-determined or defined), such as in a form of a list, by a higher-layer signaling (e.g., RRC and/or MAC-CE).

The WTRU may receive DCI1, where the DCI1 indicates {TCI1, TCI2} via a first field (e.g., TCI field) of the DCI1 and schedules PDSCH1. The WTRU may transmit a first ACK in response to receiving (e.g., successfully receiving) DCI1 and/or PDSCH1.

The WTRU receives (e.g., after transmitting the first ACK) DCI2 using at least one of {TCI1, TCI2}, where the DCI2 indicates {TCI3, TCI4} via the first field (e.g., TCI field) of the DCI2 and schedules PDSCH2. The DCI2 may further indicates a selector via a second field (e.g., TCI-selection field), where the selector indicates one of the {TCI1, TCI2} that were indicated by the DCI1. The WTRU may determine that the selector indicates a second one of the {TCI1, TCI2}, which is the TCI2. In response to the determining, the WTRU may receive the scheduled PDSCH2 by using the selected TCI2. The WTRU may transmit (e.g., using the current TCI state and/or whatever applicable TCI state is based on the current rules) a second ACK in response to receiving (e.g., successfully receiving) DCI2 and/or PDSCH2.

The WTRU may receive (e.g., after transmitting the second ACK) DCI3 using at least one of {TCI3, TCI4}, where the DCI3 indicates {TCI5, TCI6} via the first field (e.g., TCI field) of the DCI3 and schedules PDSCH3 which is transmitted k0 after the DCI3 is transmitted. The value of k0 may be indicated in the same DCI3. The WTRU may determine that the value of k0 is less than a threshold, where the threshold is a part of WTRU capability parameters (e.g., that are reported to the base station). The WTRU may receive the scheduled PDSCH3 using a default TCI X, on condition that the value of k0 is less than the threshold. The WTRU may transmit a third ACK in response to receiving (e.g., successfully receiving) DCI3 and/or PDSCH3. In one instance, the WTRU uses TCI5 or TCI6 for receiving another PDSCH or PDCCH after receiving PDSCH3 or after transmitting the third ACK

The default TCI X may be determined based on at least the most recently selected TCI(s), by the TCI-selection field of a DCI, where the WTRU determines the DCI is the DCI2 and the most recent selected TCI(s) is the TCI2, on condition that the DCI3 scheduling the PDSCH3 is received a time duration after transmitting the second ACK in response to receiving the DCI2. The time duration may be determined based on a beam application time (BAT) parameter configured from the base station and/or reported by the WTRU as a part of WTRU capability parameters.

A default UTCI state, which may be TCI Y, may be associated with a CORESET with a pre-defined or pre-configured CORESET index (e.g., UTCI(s) associated with a CORESET with a lowest (or highest) ID).

In some cases, there may be a UTCI update timeline and UTCI selection for a data reception. A WTRU may currently use and/or apply {TCI3, TCI7} for communication with a base station (e.g., gNB). The WTRU may receive DCI1 indicating {TCI3, TCI7}, which are the same ones as the currently used ones (e.g., via a TCI field of the DCI1), and scheduling PDSCH1 (e.g., data packet), which is transmitted k0 after the DCI1 is transmitted, where the value of k0 may be indicated in the same DCI1 or via a separate signaling. The DCI1 may further indicate a selector (e.g., via a TCI-selection field), where the selector may select at least one of the currently used ones, such as {TCI3, TCI7}. The currently used ones may be determined with respect to a time instance on receiving the DCI1. An example of the TCI-selection field may be comprised by at least one codepoint of the following: Codepoint ‘00’ of the TCI-selection field, Apply 1st one; Codepoint ‘01’ of the TCI-selection field, Apply 2nd one; Codepoint ‘10’ of the TCI-selection field, Apply both; Codepoint ‘11’ of the TCI-selection field, Reserved; Codepoint ‘X’ of the TCI-selection field, Apply none (e.g., meaning apply a default TCI(s) and/or beam(s)); Codepoint Y′ of the TCI-selection field, Apply the one(s) that is/are used for a CORESET(s) or a PDCCH reception(s); Codepoint ‘Z’ of the TCI-selection field, Apply 3rd one (if more than 2 UTCI states are used at a time); Codepoint ‘Z1’ of the TCI-selection field, Apply 1st one and 3rd one (if more than 2 UTCI states are used at a time); and/or, the like.

In an example, the WTRU may determine that the TCI-selection field of the DCI1 indicates a value (e.g., Codepoint ‘00’) which corresponds to applying 1st one, that is {TCI3}, such as among the currently used ones {TCI3, TCI7}. The WTRU may determine that the indicated k0 (e.g., as a scheduling offset) is greater than a threshold, denoted as Th, where the threshold may be based on the WTRU's capability which may be reported by the WTRU. If k0 is greater than (or equal to) the threshold, the WTRU may (be able to) decode contents carried by the DCI1, such as due to having a sufficient decoding time necessary for the WTRU to interpret the contents indicated by the DCI1. Otherwise, the WTRU may not apply the contents due to not sufficient decoding time before receiving the PDSCH1, then the WTRU may need to receive the PDSCH1 by using a default TCI state(s). It may be because, once the WTRU receives the PDSCH1, there are at least one parameter or component, (e.g., a spatial-domain (receive) filter or analog-filter coefficient(s), etc.) that cannot be changed or adjusted by a post-processing on the received PDSCH1 (e.g., after receiving the PDSCH1).

The WTRU may receive the scheduled PDSCH1 based on {TCI3} indicated by the selector (e.g., by the TCI-selection field).

The WTRU may apply the indicated {TCI3, TCI7} by the TCI field of DCI1 after (1) receiving the scheduled PDSCH1, (2) transmitting a corresponding acknowledgement (e.g., HARQ-ACK), and (3) the BAT parameter, where the BAT parameter may be pre-configured, or indicated, to the WTRU (e.g., from the base station). In one instance, applying the indicated {TCI3, TCI7} in response to the DCI1 may be equivalent to maintain the currently used ones because the same {TCI3, TCI7} have been used.

In some instances, there may be one or more behaviors of the WTRU upon reception of DCI2. The WTRU may receive DCI2 indicating {TCI5, TCI8} (e.g., via a TCI field of the DCI2), which are different from the currently used ones {TCI3, TCI7} and scheduling PDSCH2 (e.g., data packet) which is transmitted k0 after the DCI2 is transmitted, where the value of k0 may be indicated in the same DCI2 or via a separate signaling. The DCI2 may further indicate a selector (e.g., via a TCI-selection field) where the selector may select at least one among the currently used ones {TCI3, TCI7}, but not among the newly indicated ones {TCI5, TCI8} yet. The currently used ones may be determined when receiving the DCI2.

In an example, the WTRU may determine that the TCI-selection field of the DCI2 indicates a value (e.g., Codepoint ‘01’) which corresponds to applying the 2nd one, that is {TCI7}, not yet {TCI8} (e.g., among the currently used ones {TCI3, TCI7}. The WTRU may determine that the indicated k0 (e.g., as a scheduling offset) is greater than a threshold, denoted as Th, where the threshold may be based on the WTRU's capability which may be reported by the WTRU. The WTRU may receive the scheduled PDSCH2 based on {TCI7} indicated by the selector (e.g., by the TCI-selection field).

The WTRU may apply the indicated {TCI5, TCI8} by the TCI field of DCI2 after (1) receiving the scheduled PDSCH2, (2) transmitting a corresponding acknowledgement (e.g., HARQ-ACK), and (3) the BAT parameter, where the BAT parameter may be pre-configured (or indicated) to the WTRU (e.g., from the base station). In an example, applying the indicated {TCI5, TCI8} in response to the DCI2 may be interpreted as “beam(s) or TCI(s) update” because the indicated ones {TCI5, TCI8} are different from the currently used ones {TCI3, TCI7}.

In some instances, there may be one or more behaviors of the WTRU upon reception of DCI3. The WTRU may receive DCI3 indicating {TCI5, TCI8} (e.g., via a TCI field of the DCI3), which are the same as the currently used ones {TCI5, TCI8} and scheduling PDSCH3 (e.g., data packet) which is transmitted k0 after the DCI3 is transmitted, where the value of k0 may be indicated in the same DCI3 (or via a separate signaling). The DCI3 may further indicate a selector (e.g., via a TCI-selection field), where the selector may select at least one among the currently used ones {TCI5, TCI8}. The currently used ones may be determined when receiving the DCI3.

In an example, the WTRU may determine, Th after receiving the DCI3, that the TCI-selection field of the DCI3 indicates a value (e.g., Codepoint ‘11’) which may correspond to applying both ones, that is {TCI5, TCI8} among the currently used ones {TCI5, TCI8}. However, the WTRU may receive the PDSCH3 earlier than the determination of the value in the DCI3, because the scheduling offset k0 indicated by the DCI3 is less than the threshold Th (e.g., a parameter of WTRU capability on DCI decoding and/or processing time (or latency), etc.). The WTRU may receive the scheduled PDSCH3 before determining that the k0 is less than the Th, which means the WTRU may determine at least one default beam (or TCI) to store a (e.g., any) downlink signal (including the actual PDSCH3 packet) until identifying (or decoding) contents carried by DCI3.

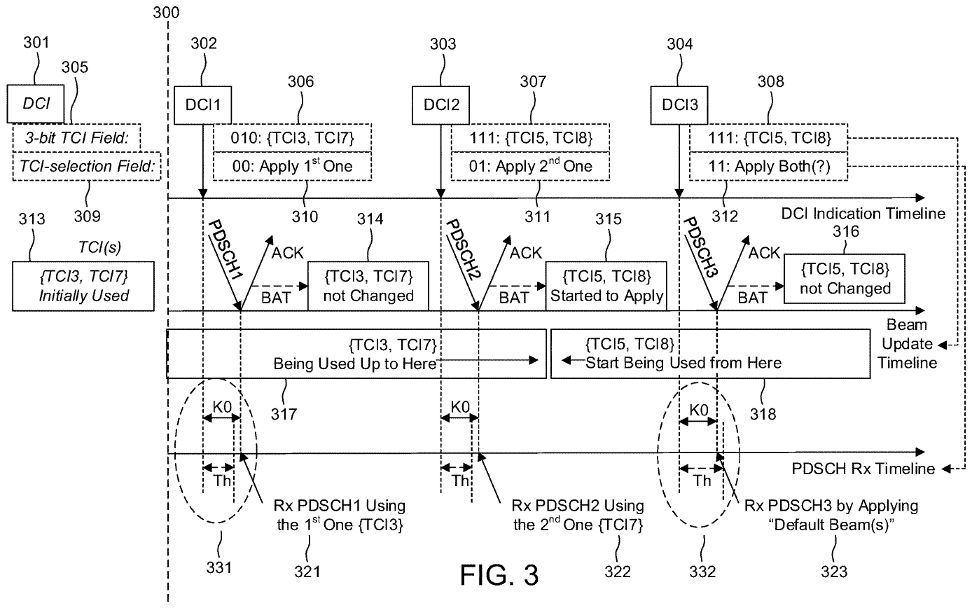

FIG. 3 illustrates an example of a UTCI update timeline and UTCI selection for data reception. From this figure, it may be understood that for a given scenario a WTRU may have an initial of TCI state(s) (e.g., pre-configured, or configured from a DCI, such as 301, as described herein); a DCI may comprise a 3-bit TCI field 305; a DCI may also have a TCI-selection field 309. Prior to 300, a WTRU may initially be configured with, use, and/or have applied a set of TCI(s) (e.g., {TCI3, TCI7} at 313) for communication with a base station (e.g., gNB). After 300, the example scenario of FIG. 3 may begin where a base station may send one or more DCIs to a WTRU. The WTRU may receive DCI1 (e.g., at 302) indicating {TCI3, TCI7} (e.g., at 306); in this example, the TCIs in DCI1 are the same TCI(s) as the initially used TCI(s) (e.g., via a TCI field of the DCI1); in one instance, the DCI1 may include scheduling PDSCH1 (e.g., data packet), which is transmitted k0 after the DCI1 is transmitted, where the value of k0 may be indicated in the same DCI1 or via a separate signaling. The DCI1 may further indicate a selector (e.g., via a TCI-selection field at 310), where the selector may select at least one of the currently used TCI(s), such as {TCI3, TCI7}. The initial set of TCI(s) may be determined with respect to a time instance on receiving the DCI1. Even though a specific codepoint in the TCI-selection Field (e.g., with a specific meaning) is shown in FIG. 3, it may be understood that the codepoint may be different with a different meaning than that which is illustrated. For example, the TCI-selection field may comprise at least one codepoint, such as one of the following: Codepoint ‘00’ of the TCI-selection field, Apply 1st one; Codepoint ‘01’ of the TCI-selection field, Apply 2nd one; Codepoint ‘10’ of the TCI-selection field, Apply both; Codepoint ‘11’ of the TCI-selection field, Reserved; Codepoint ‘X’ of the TCI-selection field, Apply none (e.g., meaning apply a default TCI(s) and/or beam(s); Codepoint ‘Y’ of the TCI-selection field, Apply the one(s) that is/are used for a CORESET(s) or a PDCCH reception(s); Codepoint ‘Z’ of the TCI-selection field, Apply 3rd one (if more than 2 UTCI states are used at a time); Codepoint ‘Z1’ of the TCI-selection field, Apply 1st one and 3rd one (if more than 2 UTCI states are used at a time); and/or, the like.

In an example, the WTRU may determine that the TCI-selection field of the DCI1 indicates a value (e.g., Codepoint ‘00’) (e.g., at 310), which corresponds to applying a 1st TCI, that is {TCI3}, such as among the currently used TCI(s) {TCI3, TCI7}. The WTRU may determine that the indicated k0 (e.g., as a scheduling offset) is greater than a threshold, denoted as Th (e.g., see k0 being greater than Th at 331); in one instance, the threshold may be based on the WTRU's capability; in one instance, the capability may be reported by the WTRU. If k0 is greater than (or equal to) the threshold (e.g., at 331), the WTRU may (be able to) decode contents carried by the DCI1, such as due to having a sufficient decoding time necessary for the WTRU to interpret the contents indicated by the DCI1. Otherwise, the WTRU may not apply the contents due to not sufficient decoding time (e.g., as shown at 332 where k0 is less than Th); in such a case, the WTRU may not apply the contents before receiving the PDSCH1, then the WTRU may need to receive the PDSCH1 by using a default TCI state(s) (e.g., not shown, but evident from one or more illustrated elements/aspects of the example of FIG. 3, and/or as further described herein). It may be because, once the WTRU receives the PDSCH1, there are at least one parameter or component, (e.g., a spatial-domain (receive) filter or analog-filter coefficient(s), etc.) that cannot be changed or adjusted by a post-processing on the received PDSCH1 (e.g., after receiving the PDSCH1). Note, as is evident from the above, one or more permutations of the example shown in FIG. 3 are described herein that do not necessarily align with what is illustrated, which emphasizes the point that it is intended that the example of FIG. 3 serve as the basis for one or more possible permutations, using one or more elements/aspects from the illustration, where the one or more possible permutations may be not be described in full but may be self-evident from one or more elements/aspects of what is shown and what is generally described herein; said another way, it is intended that one or more elements/aspects of any given figure (e.g., as described or shown) is optional, and intended to serve as the basis for one or more permutations.

As shown, the WTRU may receive the scheduled PDSCH1 based on {TCI3} indicated by the selector (e.g., by the TCI-selection field).

The WTRU may apply the indicated {TCI3, TCI7} by the TCI field of DCI1 after (1) receiving the scheduled PDSCH1, (2) transmitting a corresponding acknowledgement (e.g., HARQ-ACK), and (3) the BAT parameter, where the BAT parameter may be pre-configured, or indicated, to the WTRU (e.g., from the base station). In one instance, applying the indicated {TCI3, TCI7} in response to the DCI1 may be equivalent to maintaining the TCI(s) already in use because the same {TCI3, TCI7} where initially being used prior to receiving DCI1.

In some instances, there may be one or more behaviors of the WTRU upon reception of DCI2 (e.g., at 303). The WTRU may receive DCI2 indicating {TCI5, TCI8} (e.g., via a TCI field of the DCI2 at 307), which are different from the a set of TCI(s) that are currently used, such as {TCI3, TCI7}, and scheduling PDSCH2 (e.g., data packet) that is transmitted k0 after the DCI2 is transmitted, where the value of k0 may be indicated in the same DCI2 or via a separate signaling. The DCI2 may further indicate a selector (e.g., via a TCI-selection field at 311) where the selector may select at least one among the currently used TCI(s) {TCI3, TCI7}, but not among the newly indicated TCI(s) {TCI5, TCI8} yet. The currently used TCI(s) may be determined when receiving the DCI2.

In an example, the WTRU may determine that the TCI-selection field of the DCI2 indicates a value (e.g., Codepoint ‘01’) which corresponds to applying the 2nd one, that is {TCI7}, not yet {TCI8} (e.g., among the currently used TCI(s) {TCI3, TCI7}. The WTRU may determine that the indicated k0 (e.g., as a scheduling offset) is greater than a threshold, denoted as Th; in one instance, the threshold may be based on the WTRU's capability; in one instance, the capability may be reported by the WTRU. The WTRU may receive the scheduled PDSCH2 based on {TCI7} indicated by the selector (e.g., by the TCI-selection field).

The WTRU may apply the indicated {TCI5, TCI8} by the TCI field of DCI2 after (1) receiving the scheduled PDSCH2, (2) transmitting a corresponding acknowledgement (e.g., HARQ-ACK), and (3) the BAT parameter, where the BAT parameter may be pre-configured (or indicated) to the WTRU (e.g., from the base station) (e.g., as shown at 318). In an example, applying the indicated {TCI5, TCI8} in response to the DCI2 may be interpreted as “beam(s) or TCI(s) update” because the indicated TCI(s) {TCI5, TCI8} are different from the currently used TCI(s) {TCI3, TCI7}.

In some instances, there may be one or more behaviors of the WTRU upon reception of DCI3 (e.g., at 304). The WTRU may receive DCI3 indicating {TCI5, TCI8} (e.g., via a TCI field of the DCI3 at 308), which are the same as the currently used TCI(s) {TCI5, TCI8} and scheduling PDSCH3 (e.g., data packet) which is transmitted k0 after the DCI3 is transmitted, where the value of k0 may be indicated in the same DCI3 (or via a separate signaling). The DCI3 may further indicate a selector (e.g., via a TCI-selection field at 312), where the selector may select at least one among the currently used TCI(s) {TCI5, TCI8}. The currently used TCI(s) may be determined when receiving the DCI3.

In an example, the WTRU may determine, Th after receiving the DCI3, that the TCI-selection field of the DCI3 indicates a value (e.g., Codepoint ‘11’) which may correspond to applying both TCI(s), that is {TCI5, TCI8} among the currently used TCI(s) {TCI5, TCI8}. However, the WTRU may receive the PDSCH3 earlier than the determination of the value in the DCI3, because the scheduling offset k0 indicated by the DCI3 is less than the threshold Th (e.g., a parameter of WTRU capability on DCI decoding and/or processing time (or latency), etc., as shown at 332). The WTRU may receive the scheduled PDSCH3 before determining that the k0 is less than the Th, which means the WTRU may determine to use at least one default beam (or TCI) to store a (e.g., any) downlink signal (including the actual PDSCH3 packet) until identifying (or decoding) contents carried by DCI3. From FIG. 3, it may be understood that, generally, a WTRU may receive a DCI that indicates a TCI field and/or a TCI selection field; after a BAT has passed, one or more TCI(s) may be applied in order to receive and/or transmit a signal/message; the TCI that is applied may depend on an offset k0 and/or an indication in a TCI selection field; in one instance, whether the offset k0 is before or after some threshold (e.g. Th) may influence the TCI(s) that is/are used. While three DCIs are shown in FIG. 3, other permutations of the example shown may exist that includes one or more of the DCIs as shown, and one or more subsequent actions as shown, and that does not necessarily require every element or event to occur as shown; said another way, it is intended that the behavior illustrated/described of the WTRU after receiving a DCI relative to the example of FIG. 3 may be implemented relative to one or more other examples as described herein. Said another way, referring to FIG. 3, a WTRU may have a threshold (Th), which is a WTRU capability parameter (e.g., that the WTRU may report the minimum required time for decoding a received DCI). For demonstration purposes, Th may be Xms, and therefore “Xms after receiving the DCI3” may mean the WTRU would only be able to decode the TCI-selection field value=‘11’ Xms after receiving the DCI3; as shown in the example, k0 is shorter than Th, so PDSCH3 is received before fully decoding of DCI3, meaning that a “default (analog) beam” needs to be determined so that the WTRU can store PDSCH3 since it will not be able to decode the DCI3 contents.

In some cases (e.g. as described herein and/or illustrated in one or more figures), a device may determine a default beam, or TCI, for DL reception. In one case, at least one default beam or TCI used for receiving (e.g., storing and decoding) one or more downlink signals (e.g., including a PDSCH scheduled by a third DCI, such as the DCI3) may be defined, pre-determined, or pre-configured based on or more factors, as described herein.

For example, a default beam/TCI for one or more downlink signals may be determined based on the most recent selected TCI(s), by a TCI-selection field of a second DCI (e.g., the DCI2), among one or more TCI states indicated by a TCI field of a first/initial DCI (e.g., the DCI1). DCI3 may be received after DCI2, and DCI2 may be received after DCI1; said another way, while DCIs described herein are numbered, the numbers may or may not be read with an order implied by the numbering (e.g., receiving by the WTRU and/or sending by a base station), meaning it is intended that a given DCI described herein with a specific number may occur before or after relative to another DCI regardless of the numbering. In an example, as illustrated in FIG. 3, the WTRU may determine that the most recent selected TCI(s) by the TCI-selection field of DCI2 is the 2nd one, which is {TCI7}, (corresponding to the codepoint ‘01’ of the TCI-selection field), among the {TCI3, TCI7} indicated by the TCI field of DCI1. In response to the determining, the WTRU may receive (e.g., store and decode) one or more downlink signals (including the PDSCH scheduled by the DCI3) using TCI7, as the determined at least one default beam or TCI, although the WTRU may decode the DCI3 (e.g., later, after Th) indicating a different codepoint (e.g., ‘11’) of the TCI-selection field of the DCI3.

For example, a default beam/TCI for one or more downlink signals may be determined based on the most recent selected TCI(s), by a TCI-selection field of a second DCI (e.g., the DCI2), among one or more TCI states indicated by a TCI field of a first DCI (e.g., the DCI1), where the most recent selected TCI(s) is used as the at least one default beam or TCI after a time offset upon receiving the DCI2. In one instance, the time offset may be determined as between receiving the DCI2 and transmitting an acknowledgement (e.g., HARQ-ACK) in response to the DCI2. This may provide benefits in terms of robustness of beam control, since the determined at least one default beam or TCI is only applicable after the corresponding ACK transmission from the WTRU. In one instance, the time offset may be explicitly configured (or indicated) to the WTRU.

For example, a default beam/TCI for one or more downlink signals may be determined based on the pre-determined TCI(s) based on a current mapping table between a codepoint and the one or more TCI states, as illustrated in FIG. 2, indicated by a TCI field of a DCI being received most recently on condition that a BAT in response to the DCI has passed, where the at least one default beam (or TCI) may be determined by a column-index j (e.g., j=0, 1) and/or by a row-index c (e.g., c=0, 1, 2, . . . 7, in case of 3-bit TCI field). In one instance, the at least one default beam (or TCI) may be defined (or determined) as a TCI corresponding to (j=0, c=0) (e.g., the first indicated TCI), which relative to the example of FIG. 2 is UTCI2. In one instance, the at least one default beam (or TCI) may be defined (or determined) as a TCI corresponding to some combination of j and c, such as (j=0, c=7), which relative to the example of FIG. 2 is UTCI5; said another way, based on the example of FIG. 2 and as further described above, it may be understood that the default beam may be one or more of the TCI(s) indicated in the index as shown in FIG. 2, and that the indication of the default beam may be indicated relative to a mapping of code points to TCI(s) (e.g., an index, list, table, etc.).

For example, a default beam/TCI for one or more downlink signals may be determined based on the UTCI(s) associated with a CORESET with a pre-defined or pre-configured CORESET index. For instance, UTCI(s) associated with a CORESET with a lowest (or highest) ID.

For example, a default beam/TCI for one or more downlink signals may be determined based on a default TRP(s), where a primary or default TRP may be determined or pre-configured or indicated (e.g., with a confirmation signal, such as ACK, transmitted from WTRU). In instance, the default TRP may be represented by the column-index j of the current mapping table between a codepoint and the one or more TCI states, as illustrated in FIG. 2.

For example, a default beam/TCI for one or more downlink signals may be determined based on the more than one default UTCI that may be defined or configured or used (e.g., for a joint transmission (JT) case from more than one TRP, such as coherent JT (CJT), etc.).

In an example, the WTRU may determine that the DCI3 does not comprise a TCI field, such as DCI format 1_0, while the DCI1 and/or DCI2 may be a DCI comprising a TCI field, such as DCI format 1_1 or 1_2. In response to determining, the WTRU may receive a PDSCH scheduled by the DCI3 by using the at least one default beam or TCI.

In some cases, a device (e.g., WTRU, base station, or the like as described herein) may determine a default beam, or TCI, for DL reception when TCI selection field is not present in a DCI. In one case, at least one default beam/TCI used for receiving (e.g., storing and decoding) one or more downlink signals (e.g., including a scheduled PDSCH) may be defined, pre-determined, or pre-configured, when the TCI-selection field is not comprised or present in a DCI (e.g., where the presence of the TCI-selection field may be configurable by a higher-layer signaling). The default beam/TCI used for receiving one or more downlink signals may be based on one or more factors.

For example, the default beam/TCI used for receiving one or more downlink signals may be based on pre-determined TCI(s) based on a current mapping table between a codepoint and the one or more TCI states, as illustrated in FIG. 2, indicated by a TCI field of a DCI being received most recently on condition that a BAT in response to the DCI has passed, where the at least one default beam (or TCI) may be determined by a column-index j (e.g., j=0, 1) and/or by a row-index c (e.g., c=0, 1, 2, . . . 7, in case of 3-bit TCI field). In one instance, the at least one default beam (or TCI) may be defined (or determined) as a TCI corresponding to (j=0, c=0) (e.g., the first indicated TCI), which relative to the example of FIG. 2 is UTCI2. In another instance, the at least one default beam (or TCI) may be defined (or determined) as a TCI corresponding to some other j and c combination, such as (j=0, c=7), which relative to the example of FIG. 2 is UTCI5.

For example, the default beam/TCI used for receiving one or more downlink signals may be based on UTCI(s) associated with a CORESET with a pre-defined or pre-configured CORESET index (e.g., UTCI(s) associated with a CORESET with a lowest (or highest) ID).

For example, the default beam/TCI used for receiving one or more downlink signals may be based on a default TRP(s), such as where a primary or default TRP may be determined or pre-configured or indicated (e.g., with a confirmation signal, such as ACK, transmitted from WTRU). For instance, the default TRP may be represented by the column-index j of the current mapping table between a codepoint and the one or more TCI states, as illustrated in FIG. 2.

For example, the default beam/TCI used for receiving one or more downlink signals may be based on more than one default UTCI that may be defined or configured or used (e.g., for a joint transmission (JT) case from more than one TRP, such as coherent JT (CJT), etc.).

In some cases, there may be a timeline for UL beam determination based on a UTCI selector in a UL-DCI. In one case, a WTRU may receive configuration of a plurality of transmission configuration indicator (TCI) states (e.g., unified TCI (UTCI) states), each applicable for multiple channel(s) or signal(s). The multiple channel(s) or signal(s), associated with a TCI state, may be sent in a configuration message to the WTRU or pre-determined or defined (e.g., in a form of a list, index, table, or the like as described herein), by a higher-layer signaling (e.g., RRC and/or MAC-CE).

The WTRU may receive a first indication of a first one or more TCI states, such as via a TCI field in a first DCI (e.g., DL-DCI which may schedule PDSCH1), of the plurality of TCI states, where the WTRU starts to use the first one or more TCI states at time T1.

The time T1 may be determined based on at least one of a reception timing of the first DCI, a reception timing of PDSCH1, an ACK transmission timing in response to receiving the PDSCH1, and/or a beam application time (BAT) parameter (e.g., configured from the base station and/or reported by the WTRU as a part of WTRU capability parameters).

After the first indication, the WTRU may receive a second indication of second one or more TCI states, such as via the TCI field in a second DCI (e.g., DL-DCI which may schedule PDSCH2), of the plurality of TCI states, where the WTRU starts to use the second one or more TCI states at time T2. The time T2 may be determined based on at least one of a reception timing of the second DCI, a reception timing of PDSCH2, an ACK transmission timing in response to receiving the PDSCH2, and/or the BAT parameter.

The WTRU may receive a UL-DCI scheduling a PUSCH and selecting a TCI, among either the first one or more TCI states or the second one or more TCI states, to be applied for transmission of the scheduled PUSCH. The UL-DCI may comprise a UL-TCI-selection field or one or more of existing DCI fields selecting the TCI.

The WTRU may determine to apply either the first one or more TCI states or the second one or more TCI states, based on at least one of: the relationship between T1 and T2 (e.g., whether T1<T2); when the WTRU receives the UL-DCI with respect to T1 and T2 (e.g., whether reception is between T1 and T2 or after T2); when the WTRU transmits or is scheduled to transmit the PUSCH (e.g., whether the transmission is or is scheduled to be between T1 and T2 or after T2); the WTRU transmits the PUSCH using the first one or more TCI states or the second one or more TCI states based on the determination.

In one case, a WTRU may apply, or determines to apply, the first one or more TCI states or the second one or more TCI states, based on which is most recently started to be used before receiving the UL-DCI. In one instance, the WTRU selects a TCI among the second one or more TCI states being indicated by the second DCI, on condition that T1<T2 and the WTRU receives the UL-DCI after T2. In another instance, the WTRU selects a TCI among the first one or more TCI states being indicated by the first DCI, on condition that T1<T2 and the WTRU receives the UL-DCI after T1 and before T2.

In one case, a WTRU may apply, or determines to apply, the first one or more TCI states or the second one or more TCI states based on which is the most recently started to be used before transmitting the PUSCH scheduled by the UL-DCI. In one instance, the WTRU selects a TCI among the second one or more TCI states being indicated by the second DCI, on condition that T1<T2 and the WTRU transmits the PUSCH after T2. In another instance, the WTRU selects a TCI among the first one or more TCI states being indicated by the first DCI, on condition that T1<T2 and the WTRU transmits the PUSCH after T1 and before T2.

In one case, a WTRU may apply, or determines to apply, the first one or more TCI states or the second one or more TCI states based on which is the most recently started to be used at least a time offset before transmitting the PUSCH scheduled by the UL-DCI, where the time offset may be configured from the base station and/or reported by the WTRU as a part of WTRU capability parameters. In one instance the WTRU selects a TCI among the second one or more TCI states being indicated by the second DCI, on condition that T1<T2 and the WTRU transmits the PUSCH after T2 plus the time offset. In another instance, the WTRU selects a TCI among the first one or more TCI states being indicated by the first DCI, on condition that T1<T2 and the WTRU transmits the PUSCH after T1 plus the time offset and before T2 plus the time offset.

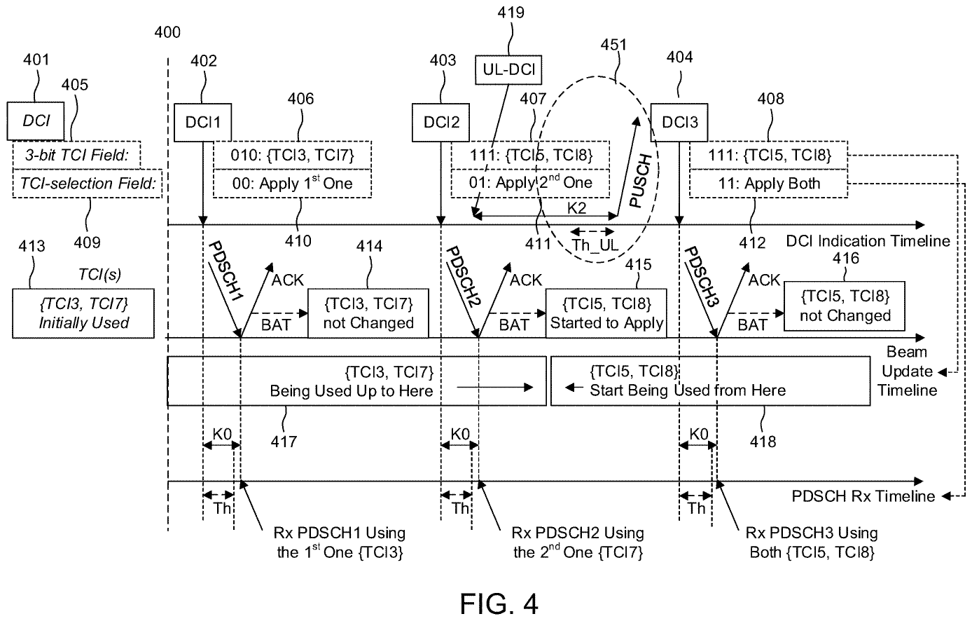

FIG. 4 illustrates an example of UTCI update timeline and UTCI selection for UL transmission. From this figure, it may be understood that for a given scenario a WTRU may have an initial of TCI state(s) (e.g., pre-configured, or configured from a DCI, such as 401, as described herein); a DCI may comprise a 3-bit TCI field 405; a DCI may also have a TCI-selection field 409. Prior to 400, a WTRU may initially use and/or apply a set of TCI(s), such as {TCI3, TCI7} at 413) (e.g., as unified TCIs applicable for multiple channel(s)/signal(s) for communication with a base station (e.g., gNB). After 400, the example scenario of FIG. 4 may begin where a base station may send one or more DCIs to a WTRU. The WTRU may receive DCI1 (e.g., at 402) (e.g., DL-DCI) indicating {TCI3, TCI7} (e.g., 406, 414), which are the same TCI(s) as the currently used TCI(s) (e.g., 413, via a TCI field of the DCI1), and scheduling PDSCH1 (e.g., data packet) which is transmitted k0 after the DCI1 is transmitted, where the value of k0 may be indicated in the same DCI1 (or via a separate signaling).

The WTRU may apply the indicated {TCI3, TCI7} by the TCI field of DCI1 after (1) receiving the scheduled PDSCH1, (2) transmitting a corresponding acknowledgement (e.g., HARQ-ACK), and (3) the BAT parameter, where the BAT parameter may be pre-configured or indicated to the WTRU (e.g., from a base station). In an example, applying the indicated {TCI3, TCI7}, (e.g., as unified TCIs applicable for multiple channel(s)/signal(s) in response to the DCI1 may be equivalent to maintaining the currently used TCI(s) because the same {TCI3, TCI7} have been used (e.g., as shown at 417).

The WTRU may receive DCI2 at 403 (e.g., DL-DCI) indicating {TCI5, TCI8} (e.g., via a TCI field of the DCI2 at 407), which are different from the currently used TCI(s) {TCI3, TCI7}, and scheduling PDSCH2 (e.g., data packet) which is transmitted k0 after the DCI2 is transmitted, where the value of k0 may be indicated in the same DCI2 (or via a separate signaling).

The WTRU may apply the indicated TCI(s) {TCI5, TCI8} by the TCI field of DCI2 after (1) receiving the scheduled PDSCH2, (2) transmitting a corresponding acknowledgement (e.g., HARQ-ACK), and (3) the BAT parameter, where the BAT parameter may be pre-configured or indicated to the WTRU (e.g., from the base station). In an example, applying the indicated TCI(s) {TCI5, TCI8} (e.g., 415) (e.g., as unified TCIs applicable for multiple channel(s)/signal(s)), in response to the DCI2 may be interpreted as “beam(s) or TCI(s) update” because the indicated TCI(s) {TCI5, TCI8} are different from the currently used TCI(s) {TCI3, TCI7} (e.g., see transition of using one set of TCIs from another set of TCIS at 417 and 418).

In one case, the WTRU may receive a UL-DCI at 419 (e.g., DCI format 0_1, 0_2) scheduling a PUSCH and comprising a TCI-selector (e.g., via a UL-TCI-selection field or one or more of existing DCI fields) where the selector may select at least one of the currently used TCI(s) (e.g., the selector could indicate the first one indicating TCI3). In another instance, the selector may apply to the new TCI and may apply one of the new TCIs (e.g., an indication of the first one for the new TCI would mean apply TCI5). The currently used TCI(s) may be determined with respect to one or more factors.

In an example, a currently used TCI(s) may be determined with respect to a time instance on receiving the UL-DCI. Then, in FIG. 4, the WTRU may determine that the currently used TCI(s) are {TCI3, TCI7} (e.g., at 417), with respect to the time instance on receiving the UL-DCI, because the time instance is before the BAT in response to the DCI2 has passed.

In an example, a currently used TCI(s) may be determined with respect to a time instance on transmitting the PUSCH scheduled by the UL-DCI (e.g., where the PUSCH transmission timing may be based on a ‘k2’ parameter indicated by the UL-DCI) (e.g., the PUSCH transmission timing may be k2 after receiving the UL-DCI) (e.g., see time considerations and related PUSCH at 451). Then, in FIG. 4, the WTRU may determine that the currently used TCI(s) are {TCI5, TCI8}, with respect to the time instance on transmitting the PUSCH, because the time instance is after the BAT in response to the DCI2 has passed.

In an example, a currently used TCI(s) may be determined with respect to a time instance that is Th_UL before transmitting the PUSCH scheduled by the UL-DCI (e.g., where the PUSCH transmission timing may be based on a ‘k2’ parameter indicated by the UL-DCI) (e.g., the PUSCH transmission timing may be k2 after receiving the UL-DCI). Then, in FIG. 4, the WTRU may determine that the currently used TCI(s) are {TCI5, TCI8}, with respect to the time instance that is Th_UL before transmitting the PUSCH, because the time instance is after the BAT in response to the DCI2 has passed (e.g., at 451). While not shown, more than one UL-threshold parameters (e.g., Th_UL1, Th_UL2) may be configured or used (e.g., where each UL-threshold parameter may be applied for each WTRU-panel). This may be based on assuming that the base station may know which WTRU-panel is the currently activated panel. If a deactivated panel is indicated by the UL-TCI-selection field or one or more of existing DCI fields, the Th_UL2 (e.g., which is greater than Th_UL1) may be applied. Note, as is evident from the above, one or more permutations of the example shown in FIG. 4 are described herein that do not necessarily align with what is illustrated, which emphasizes the point that it is intended that the example of FIG. 4 serve as the basis for one or more possible permutations, using one or more elements/aspects from the illustration, where the one or more possible permutations may be not be described in full but may be self-evident from one or more elements/aspects of what is shown and what is generally described herein; said another way, it is intended that one or more elements/aspects of any given figure (e.g., as described or shown) is optional, and intended to serve as the basis for one or more permutations.

In an example, a currently used TCI(s) may be determined with respect to a time instance (based on) that is a configurable duration such as n>=0 slots/symbols, after a point of reference in time where the point of reference may be reception of the UL-DCI, completion of the scheduled PUSCH transmission by the UL-DCI, etc. A WTRU may determine and apply the received indicated (e.g., selected) TCI state(s) upon completion of the PUSCH transmission. In one approach, a WTRU may apply the received indicated (e.g., selected) TCI state(s) immediately after completion of the scheduled PUSCH transmission, or alternatively after n slots/symbols after the completion of the PUSCH transmission. For instance, in FIG. 4, the WTRU may receive an updated UTCI information as part of UL-DCI (e.g., explicitly or implicitly, where as one example the UL-DCI may also comprise a TCI field, and the TCI field may indicate the updated UTCI information), however it continues to use TCI5 and TCI8 till completion of the PUSCH transmission. Then the WTRU may immediately or after n slots/symbols, apply the newly indicated TCI state(s) (e.g., the updated UTCI information), for future transmissions, where in one instance a future transmission may also include downlink transmissions. The configurable duration (e.g., n) may be configured by RRC and/or a MAC CE, or alternatively indicated in a DCI (e.g., the UL-DCI).

An example of the UL-TCI-selection field, or one or more of existing DCI fields, may comprise at least one codepoint of the following: Codepoint ‘00’ of the UL-TCI-selection field, Apply 1st one; Codepoint ‘01’ of the UL-TCI-selection field, Apply 2nd one; Codepoint ‘10’ of the UL-TCI-selection field, Apply both; Codepoint ‘11’ of the UL-TCI-selection field, Reserved; Codepoint ‘X’ of the UL-TCI-selection field, Apply none (e.g., meaning apply a default TCI(s) and/or beam(s); Codepoint ‘Y’ of the UL-TCI-selection field, Apply the one(s) that is/are used for a CORESET(s) or a PDCCH reception(s); Codepoint ‘Z’ of the UL-TCI-selection field, Apply 3rd one (if more than 2 UTCI states are used at a time); and/or, Codepoint ‘Z1’ of the UL-TCI-selection field, Apply 1st one and 3rd one (if more than 2 UTCI states are used at a time).

Generally, as described herein a WTRU may transmit a PUSCH using the determined at least one (e.g., TCI(s)) of the currently used ones being determined with respect to the time instance (e.g., a WTRU such as that described with respect to the example of FIG. 4).

In one case, there may be linked beam control for UL channel/signal associated with dynamic PUSCH beam selection. In one approach, the determined at least one (e.g., TCI(s) of the currently used ones being determined with respect to the time instance may (also) be applicable to other UL channels/signals (e.g., configured grant (CG)-PUSCH, PUCCH, SRS, PRACH, etc.), based on base station(s) configuration for the linked beam control mechanism. For such an approach, at least one of the following may apply: per particular channel/signal, where the configured-grant (CG)-PUSCH resource or configuration, PUCCH resource and/or resource group, SRS resource and/or resource set, PRACH resource or config, the base station may configure or indicate a flag (or parameter) indicating that this channel and/or signal follows the most recent indication by the UL-TCI-selection field or one or more of existing DCI fields (of a UL-DCI); and/or, for Type-2 CG-PUSCH, after being activated by an activation DCI, the beam control may be linked to the UL-TCI-indication field (of a UL-DCI, such as scheduling a dynamic-grant PUSCH).

A WTRU may send a transmission using any of a plurality of uplink channels, such as PUSCH, PUCCH, SRS, PRACH, etc. Further, a WTRU may employ one of a plurality of transmission strategies, such as single or multi-TRP transmission. Therefore, the procedure related to indication, maintenance, and update of UL-TCI may be applicable to all channels and transmission methods. Since change of an uplink beam often rises from a change in transmission environment, such as mobility, blockage, etc., a WTRU may perform update of more than one UL-TCI state at the time to reduce signaling overhead.

In one approach, a WTRU may be configured with (or indicated by) at least one beam or UL-TCI per channel, where the combination of the configured UL-TCI may be configured by RRC signaling or jointly by a combination of RRC and MAC signaling. Table 1 shows an example configuration of UL-TCI per channel.

TABLE 1
Examples of Configuration of UL-TCI per Channel

| | |
|---|---|
| Channels | Signals |

| | | | |
|---|---|---|---|
| PUSCH | UL-TCI-1 | UL-TCI-2 | UL-TCI-3 |
| PUCCH | UL-TCI-3 | UL-TCI-2 | UL-TCI-1 |
| SRS | UL-TCI-1 | UL-TCI-3 | |
| PRACH | UL-TCI-1 | UL-TCI-2 | |

In one approach, when a WTRU receives a scheduling DCI for an uplink transmission, it may also receive an UL-TCI selection field to select the UL-TCI for the transmission. The TCI selection field may include one or more indications for selection of the UL-TCI. In an example, a WTRU may first receive a configuration (e.g., an RRC configuration), for the configured number of DCI fields intended for simultaneous indication of UL-TCIs. For instance, an RRC configuration with parameter that related to UL TCI configuration (e.g., ulTCI_FieldConfig) may be considered as (e.g., and/or be received to the WTRU): field1 for PUSCH, N1 entries; field2 for PUCCH, N2 entries; field3 for SRS, N3 entries; and/or field4 for PRACH, N4 entries.

Once configured, in one situation, a WTRU may receive a DCI with M fields where each field may select an UL-TCI for its corresponding configured channel. In another situation, a WTRU configured for multi-TRP operation may be configured for more than one field for one or more of its uplink channels or signals. For example, a WTRU may be configured with more than one field for PUSCH to support uplink multi-TRP transmission.

In one scenario, a WTRU may operate multiple antenna panels. The WTRU may report one or more WTRU capability parameters associated with multiple WTRU panels, such as a number of WTRU-panels, how many WTRU-panels can be simultaneously activated to communicate with a TRP (e.g., cell, gNB, base station, WTRU, etc.), etc. Each WTRU-panel of the multiple WTRU panels may have one or more functionality of the following: a separate group of antennas or antenna ports (e.g., a sub-array) to receive or transmit a signal based on an independent spatial-domain filter (e.g., spatial Rx parameter, analog beamforming coefficients, and/or polarization-domain parameter or coefficients, etc.); an independent power control entity, which means different power control mechanisms or indications may apply for different WTRU-panels; and/or, an independent timing control entity, which means different timing control mechanisms or indications may apply for different WTRU-panels. The WTRU may receive configuration of multi-panel WTRU (MPWTRU) related parameters, which may comprise multiple SRS resource sets, each associated with each WTRU-panel.

When a WTRU reports multi-panel capability (MPWTRU), the configuration of the UTCI may be related to the antenna panel grouping based on the full, partial, and/or non-coherent characteristic of the WTRU antenna system for UL transmissions; from this it may be understood that an indication of the configuration in the reporting could be implicit or explicit.

An MPWTRU that reports “non-coherent” and fullPowerMode2 may be configured with two SRS resource sets that may be split between non-coherent antenna sub-groups (e.g., panel). In this case, the SRS resource set may be associated per panel and the UTCI selector for beam selection may follow the SRS resource set associated with the panel. In this case, the PUSCH transmission on STxMP mode per panel is associated with the SRS resource set mapped per panel.

An MPWTRU that reports “partial and non-coherent” may have panel coherent and inter-panel non-coherent capability. In this case, the SRS resource set may be associated with the panel (e.g., panel group) coherency split. If a fullPowerMode2 is configured, the WTRU may expect at least two sets of SRS resource sets that may be associated with the panel-beam by the UTCI selector.

An MPWTRU that reports “full and partial coherent” capability for its antenna system, may be configured with one or two SRS resource sets. If the MPWTRU is configured with fullPowerMode1 and one SRS resource set, then the UTCI active panel is considered for current transmission on the current beam.

If the WTRU is configured with fullPowerMode 2 and two SRS resource sets, then the UTCI selector may be associated with the SRS resource set and may be linked to a coherent panel or panel group that is associated to a beam.

In one case, a WTRU may determine a UL TCI state(s) per panel. When the WTRU transmits on more than one panel simultaneously in the same time slot/symbol, the WTRU may be considered to be operating in the Simultaneous Transmission over Multiple Panels (STxMP) mode of operation. The WTRU may receive a dynamic indication in a DCI (e.g., SRS resource set indicator), and the WTRU may determine to switch between single panel and STxMP transmission as a function of the dynamic indication.

In one approach, a WTRU may receive an UL-DCI which may contain an indication with multiple TCI states, and an indication (e.g., UL TCI state selector, such as based on a UL-TCI-selection field or one or more of existing DCI fields of the UL-DCI) to select one or more (UL) TCI states. The UL-DCI may contain a grant to schedule a PUSCH, and the WTRU may transmit the PUSCH with the selected TCI state(s). The WTRU may determine that the PUSCH may be transmitted in a mode of operation where more than one panel may be used simultaneously. The TCI state selector may indicate the association between the TCI state and the one or more SRS resources configured in an SRS resource set(s). The TCI state selector may indicate the panel indices associated with each of the SRS resource sets. For example, a first panel may be associated to a first SRS resource set, or to a second SRS resource set. A WTRU may determine the power control parameters (e.g., P0, alpha, TPC) per SRS resource set as a function of the associated panel indicated by the UL TCI state selector.

If the UL TCI state selector indicates two UL TCI states to use, a WTRU may transmit the PUSCH in STxMP mode of operation with the two indicated UL TCI states. As part of its WTRU capability, a WTRU may signal a threshold timing per panel. If the WTRU is scheduled for a PUSCH transmission that occurs at a time T1 that is greater than both of the threshold timings per panel from the time of the UL TCI state reception, then the WTRU may use the newly indicated UL TCI states for STxMP. If the WTRU is scheduled for a PUSCH transmission that occurs at a time T1 that is less than at least one of the threshold timing per panel from the time of the UL TCI state reception, the WTRU may not apply the newly indicated UL TCI states for STxMP until the reception of the next grant for a STxMP transmission, and the WTRU may apply the UL TCI states for the current STxMP transmission using one of the following rules: the WTRU may transmit in STxMP using UL TCI state(s) per panel that were active at the time of the reception of the UL DCI; the WTRU may fall back to single panel transmission, where one of the panels is preconfigured as the default single panel operation with a default UL TCI state; and/or, the WTRU may fall back to single panel transmission on the panel with the threshold timing less than T1.

Alternatively, the UL TCI state selector may indicate a single UL TCI state, and the WTRU may determine to transmit on a single panel. The WTRU may determine the panel amongst the multiple panels based on the indication in the UL TCI state selector.

In another approach, if a separate indicator in the UL DCI indicates STxMP mode of operation, and the TCI state selector indicates only one UL TCI state, a WTRU may transmit STxMP mode of operation using the newly indicated TCI state on a first panel and using an implicitly predetermined UL TCI state on the second panel. The predetermined UL TCI state may be one of the following: a preconfigured UL TCI state that is paired with the indicated UL TCI state (e.g., TCI states 1 and 2 may be preconfigured with an association for STxMP, where if a WTRU receives an UL TCI state indication for TCI state 1, then a WTRU may implicitly determine to use TCI state 2 simultaneously in STxMP); the last UL TCI state used on the second panel in either single panel or STxMP; or the UL TCI state associated with the lowest PUCCH resource ID of the second panel.

If the UL DCI indicates STxMP mode of operation, and the UL TCI state selector does not indicate any UL TCI states, a WTRU may transmit in STxMP mode of operation using a default configured pair of UL TCI states for STxMP. The default pair may be explicitly preconfigured, or implicitly determined. For example: the last pair of UL TCI states used for STxMP; UL TCI states with the lowest ID per panel, or associated to the SRS resources with the lowest ID in a SRS resource set); and/or UL TCI states associated with the lowest PUCCH resource IDs per panel.

In some situations, a MPWTRU may operate with one or more specific behavior(s), as described herein.

A WTRU may receive configuration of a plurality of transmission configuration indicator (TCI) states, (e.g., unified TCI (UTCI) states), each applicable for multiple channel(s) or signal(s). The multiple channel(s) or signal(s), associated with a TCI state, may be sent in a configuration message to the WTRU (or pre-determined or defined), such as in a form of a list, by a higher-layer signaling (e.g., RRC and/or MAC-CE).

A WTRU may receive an indication of one or more TCI states, such as via a TCI field in a first DCI (e.g., DL-DCI which may schedule PDSCH1), of the plurality of TCI states, where the WTRU starts to use the one or more TCI states at time T1. The time T1 may be determined based on at least one of a reception timing of the first DCI, a reception timing of PDSCH1, an ACK transmission timing in response to receiving the PDSCH1, and a beam application time (BAT) parameter, such as configured from the base station and/or reported by the WTRU as a part of WTRU capability parameters.

A WTRU may receive an UL-DCI (e.g., after T1 and/or using one of the one or more TCI states), scheduling a PUSCH and selecting at least one TCI, among the one or more TCI states, to be applied for at least one transmission of the scheduled PUSCH, one or more SRS resources, a second PUSCH, a PUCCH, and/or a PRACH. The WTRU may determine the at least one transmission, based on an explicit configuration from a base station or an implicit determination. The UL-DCI may comprise a UL-TCI-selection field or one or more of existing DCI fields selecting the at least one TCI. The one or more SRS resources may be within at least one SRS resource set of the multiple SRS resource sets, each associated with each WTRU-panel and/or a UL Tx mode, such as a codebook-based UL Tx mode, or a non-codebook-based UL Tx mode, etc.

In one example, on a condition that the determination of the at least one transmission is comprising the scheduled PUSCH, the WTRU transmits, based on the selected at least one TCI, the PUSCH scheduled by the UL-DCI, such as a simultaneous transmission from multiple WTRU panels (STxMP) by applying each of the at least one TCI to each WTRU-panel for the STxMP transmission.

In a second example, on a condition that the determination of the at least one transmission is comprising the scheduled PUSCH and the one or more SRS resources, the WTRU transmits, based on the selected at least one TCI, the PUSCH scheduled by the UL-DCI, such as an STxMP transmission by applying each of the at least one TCI to each WTRU-panel, and/or At time T2, the WTRU starts to transmit, based on the selected at least one TCI, one or more SRS transmissions over the one or more SRS resources. The time T2 may be determined based on at least one of a reception timing of the UL-DCI, a transmission timing of the PUSCH scheduled by the UL-DCI, and a UL-BAT parameter (which may be different from the BAT parameter), such as configured from the base station and/or reported by the WTRU as a part of WTRU capability parameters. After time T2, the WTRU may receive a second UL-DCI scheduling a second PUSCH, with or without selecting a TCI (e.g., by the UL-TCI-selection field or one or more of existing DCI fields), and comprise multiple SRS resource indication (SRI) fields, each associated with each WTRU-panel. On a condition that the WTRU determines the second PUSCH is to be transmitted by following the same UL beam(s) (or TCI(s) used for previous (e.g., most recent, before receiving the second UL-DCI) SRS transmission(s) over at least one SRS resource indicated by the SRI field(s), the WTRU may transmits the second PUSCH using the determined same UL beam(s) or TCI(s) associated with the at least one SRS resource indicated by the SRI field(s) of the UL-DCI. The WTRU may receive the second UL-DCI which may dynamically inform the WTRU of applying either a selected TCI(s) (e.g., by the UL-TCI-selection field or one or more of existing DCI fields) or applying the same UL beam(s) or TCI(s) associated with the at least one SRS resource indicated by the SRI field(s) of the UL-DCI.

In a third example, on a condition that the determination of the at least one transmission is comprising the one or more SRS resources, the WTRU transmits, based on following the same UL beam(s) (or TCI(s)) used for previous (e.g., most recent, before receiving the UL-DCI) SRS transmission(s) over at least one SRS resource indicated by the SRI field(s) of the UL-DCI, the PUSCH scheduled by the UL-DCI. At time T2, the WTRU starts to transmit, based on the selected at least one TCI, one or more SRS transmissions over the one or more SRS resources. The time T2 may be determined based on at least one of a reception timing of the UL-DCI, a transmission timing of the PUSCH scheduled by the UL-DCI, and a UL-BAT parameter (which may be different from the BAT parameter), such as configured from the base station and/or reported by the WTRU as a part of WTRU capability parameters.

In some situations, MPWTRU(s) may operate with multiple SRI fields and/or TPMI fields. The WTRU may receive a DCI comprising a first SRS resource indicator field (SRI field), a second SRI field, a first transmit precoding matrix indicator field (TPMI field), and a second TPMI field. In an example, the first SRI field indicating at least one SRS resource and the first TPMI field indicating a precoding matrix and a rank (number of PUSCH layers) are associated with (e.g., mapped with, corresponding to) the first WTRU-panel. In an example, the second SRI field indicating at least one SRS resource and the second TPMI field indicating a precoding matrix and a rank (number of PUSCH layers) are associated with (e.g., mapped with, corresponding to) the second WTRU-panel.

In at least one case, it may be assumed that the WTRU received, before a certain amount of time, an indication of one or more TCI states (e.g., UTCIs) (e.g., via a TCI field in a DL-DCI) which are assumed to be used as UTCIs currently (e.g., at a time of receiving a DCI) (e.g., UL-DCI).

In one approach, there may be a per-WTRU-panel beam determination/update with UTCI (e.g., via a UTCI-selector field (e.g., 2-bit) (e.g., in a DL-DCI, or in a UL-DCI).

A WTRU may receive a control signal (e.g., via a MAC-CE and/or RRC) where at least one codepoint (e.g., ‘00’, ‘01’, ‘10’, ‘11’) of the UTCI-selector field may be described (or configured) to perform an action based on one or more behaviors.

In a first scenario, the WTRU may receive a control signal (e.g., via a MAC-CE and/or RRC) where at least one codepoint (e.g., ‘00’, ‘01’, ‘10’, ‘11’) of the UTCI-selector field may be described (or configured) to perform an action based on applying/updating 1st, or 2nd, one (e.g., of the one or more TCI states) to the 1st, or 2nd, SRS resource set (e.g., w.r.t beam determination for the scheduled PUSCH transmission and/or next SRS transmissions over one or more SRS resources in the applied SRS resource set).

In this scenario, as described with respect to one or more examples herein, it may be assumed that the first one of the one or more TCI states is indicated by a codepoint of the UTCI-selector field, which corresponds to the 1st SRS resource set.

In a first example, (e.g., Indication by UTCI-selector only applied to the currently scheduled PUSCH transmission), a WTRU may transmit the scheduled PUSCH (e.g., STxMP) based on: a first PUSCH beam (e.g., corresponding to the first WTRU-panel) being determined by the UTCI-selector (e.g., where SRS resource selection by the first SRI field plays a role of port determination at least for PUSCH transmission); and/or a second PUSCH beam (e.g., corresponding to the second WTRU-panel) being determined by the second SRI field.

In a second example, (e.g., Indication by UTCI-selector only applied to next SRS transmission(s), a WTRU may transmit the scheduled PUSCH (e.g., STxMP) based on: a first PUSCH beam (e.g., corresponding to the first WTRU-panel) being determined by the first SRI field (e.g., where next SRS transmissions over SRS resource(s) in the first SRS resource set may be based on the indicated first one of the one or more TCI states; e.g., where the indicated 1st one may be applied to a pre-determined (e.g., first) SRS resource, and a pre-defined (or pre-configured) pattern of varying beams (spatial-domain filter coefficients) may apply for the other (rest) of SRS resources in the first SRS resource set); and/or, a second PUSCH beam (corresponding to the second WTRU-panel) being determined by the second SRI field.

In a third example, (e.g., Indication by UTCI-selector applied to both the currently scheduled PUSCH transmission and next SRS transmission(s)), a WTRU may transmit the scheduled PUSCH (e.g., STxMP) based on: a first PUSCH beam (e.g., corresponding to the first WTRU-panel) being determined by the UTCI-selector (e.g., where SRS resource selection by the first SRI field plays a role of port determination at least for PUSCH transmission; where the next SRS transmissions over SRS resource(s) in the first SRS resource set may be based on the indicated first one of the one or more TCI states, for example where the indicated first one may be applied to a pre-determined (e.g., first) SRS resource in the first SRS resource set and a pre-defined (or pre-configured) pattern of varying beams (spatial-domain filter coefficients) may apply for the other (rest) of SRS resources in the first SRS resource set); and/or, a second PUSCH beam (e.g., corresponding to the second WTRU-panel) being determined by the second SRI field.

In a second scenario, the WTRU may receive a control signal (e.g., via a MAC-CE and/or RRC) where at least one codepoint (e.g., ‘00’, ‘01’, ‘10’, ‘11’) of the UTCI-selector field may be described (or configured) to perform an action based on applying/updating both (of the one or more TCI states) to both SRS resource sets (e.g., with regard to beam determination for the scheduled PUSCH transmission and/or next SRS transmissions over one or more SRS resources in each SRS resource set).

In this scenario, in one instance, both TCI states may be applied/updated as STxMP spatial-domain multiplexing (SDM) (if the UTCI-selector field of UL-DCI is used) based on first {SRS resource set and TPMI field} for first WTRU-panel and second {SRS resource set and TPMI field} for second WTRU-panel, respectively, at least for port/layer/precoding determinations.

In this scenario, in another instance, both TCI states may be applied/updated as STxMP single-frequency network (SFN) (if the UTCI-selector field of UL-DCI is used), where the total number of layers may be determined by the first TPMI field for CB-PUSCH and the first SRS field for NCB-PUSCH, respectively.

In a first example, (e.g., Indication by UTCI-selector only applied to the currently scheduled PUSCH transmission), a WTRU may transmit the scheduled PUSCH (e.g., STxMP) based on: a first PUSCH beam (e.g., corresponding to the first WTRU-panel) being determined by the UTCI-selector (e.g., where SRS resource selection by the first SRI field plays a role of port determination at least for PUSCH transmission); and/or, a second PUSCH beam (e.g., corresponding to the second WTRU-panel) being determined by the UTCI-selector (e.g., where SRS resource selection by the second SRI field plays a role of port determination at least for PUSCH transmission).

In a second example, (e.g., Indication by UTCI-selector only applied to next SRS transmission(s)), a WTRU may transmit the scheduled PUSCH (e.g., STxMP) based on: a first PUSCH beam (e.g., corresponding to the first WTRU-panel) being determined by the first SRI field (e.g., where next SRS transmissions over SRS resource(s) in the first SRS resource set may be based on the indicated first one of the one or more TCI states; e.g., where the indicated 1st one may be applied to a pre-determined (e.g., first) SRS resource, and a pre-defined (or pre-configured) pattern of varying beams (spatial-domain filter coefficients) may apply for the other (rest) of SRS resources in the first SRS resource set); and/or, a second PUSCH beam (corresponding to the second WTRU-panel) being determined by the second SRI field (e.g., where next SRS transmissions over SRS resource(s) in the second SRS resource set may be based on the indicated second one of the one or more TCI states; e.g., where the indicated second one may be applied to a pre-determined (e.g., first) SRS resource in the second SRS resource set, and a pre-defined (or pre-configured) pattern of varying beams (spatial-domain filter coefficients) may apply for the other (rest) of SRS resources in the second SRS resource set).

In a third example, (Indication by UTCI-selector applied to both the currently scheduled PUSCH transmission and next SRS transmission(s)), the WTRU may transmit the scheduled PUSCH (e.g., STxMP) based on: a first PUSCH beam (corresponding to the first WTRU-panel) being determined by the UTCI-selector (e.g., where SRS resource selection by the first SRI field plays a role of port determination at least for PUSCH transmission; where the next SRS transmissions over SRS resource(s) in the first SRS resource set may be based on the indicated 1st one of the one or more TCI states, for example where the indicated first one may be applied to a pre-determined (e.g., first) SRS resource, and a pre-defined (or pre-configured) pattern of varying beams (spatial-domain filter coefficients) may apply for the other (rest) of SRS resources in the first SRS resource set); and/or, a second PUSCH beam (corresponding to the second WTRU-panel) being determined by the UTCI-selector (e.g., where SRS resource selection by the second SRI field plays a role of port determination at least for PUSCH transmission; where next SRS transmissions over SRS resource(s) in the second SRS resource set may be based on the indicated second one of the one or more TCI states; for example where the indicated 2nd one may be applied to a pre-determined (e.g., first) SRS resource in the second SRS resource set, and a pre-defined (or pre-configured) pattern of varying beams (spatial-domain filter coefficients) may apply for the other (rest) of SRS resources in the second SRS resource set).

A new parameter of ‘BAT_UL’ may be configured/used, where the application of the first scenario or second scenario, as described herein or any situation, may be done after BAT_UL time interval (e.g., not immediate from receiving the DL/UL DCI). For instance, if UL-DCI, the UTCI-selector field may be applied for later scheduled UL (e.g., PUSCH and/or SRS transmission, and/or other UL channels/signals).

In one case, there may be joint encoding on the SRS resource set indicator (SRSI) field codepoints (e.g., for UL-DCI case). For STxMP, an existing SRSI field may have one or more re-interpreted codepoint(s) (e.g., as joint encoding with the UTCI-selector) based on at least one of following selections: select the first SRS resource set (e.g., as sTRP fallback) and apply the first one (e.g., of the one or more TCI states indicated by a TCI field, such as of a DL-DCI) for PUSCH Tx; select the second SRS resource set (e.g., as sTRP fallback) and apply the second one (e.g., of the one or more TCI states indicated by a TCI field, such as of a DL-DCI) for PUSCH Tx; select the first and the second SRS resource sets (e.g., as STxMP) and apply the first one and the second one, respectively, of the one or more TCI states (e.g., indicated by a TCI field, such as of a DL-DCI) for PUSCH Tx; select the first and the second SRS resource sets (e.g., as STxMP) and apply the second one and the first one, respectively, of the one or more TCI states (e.g., indicated by a TCI field, such as of a DL-DCI) for PUSCH Tx. In this last selection option, it may benefit for MPWTRU and sTRP case, where the STxMP transmission with a swapped pair of beams (e.g., based on applying the second one and the first one) may be toward the sTRP, providing benefits on beam selection flexibility.

In some circumstances, the examples and scenarios described herein may be applied to one of the following: only the currently scheduled PUSCH transmission; only next SRS transmission(s); both the currently scheduled PUSCH transmission and next SRS transmission(s).

In some cases, there may be a UTCI deactivation process in a multi-stage UTCO management framework. In one case, a WTRU may receive a configuration of a plurality of transmission configuration indicator (TCI) states (e.g., unified TCI (UTCI) states), each applicable for multiple channel(s) or signal(s). The multiple channel(s) or signal(s), associated with a TCI state, may be sent in a configuration message to the WTRU, or pre-determined or defined (e.g., in a form of a list), by a higher-layer signaling (e.g., RRC and/or MAC-CE).

The WTRU may receive DCI1, where the DCI1 indicates {TCI1, TCI2} via a first field (e.g., TCI field) of the DCI1 and schedules PDSCH1. The WTRU may transmit a first ACK in response to receiving (e.g., successfully receiving) DCI1 and/or PDSCH1.

The WTRU may receive (e.g., after transmitting the first ACK) DCI2 using at least one of {TCI1, TCI2}, where the DCI2 indicates {TCI3, TCI4} via the first field (e.g., TCI field) of the DCI2 and schedules PDSCH2. The DCI2 may further indicate a selector via a second field (e.g., TCI-selection field), where the selector indicates one of the TCI states {TCI1, TCI2} that were indicated by the DCI1.

In response to receiving the DCI2, the WTRU may determine that a TCI state different from the TCI state selected by the selector is a deactivated TCI state after a time offset. The time offset may be determined based on at least one of a reception timing of the DCI2, a reception timing of PDSCH2, an ACK transmission timing in response to receiving the PDSCH2, and a beam application time (BAT) parameter (e.g., configured from the gNB and/or reported by the WTRU as a part of WTRU capability parameters). For example, if the selector indicates TCI1, the WTRU determines TCI2 is a deactivated TCI after the time offset.

The WTRU may apply, or determine to apply, at least one of the following behaviors based on the deactivated TCI: the WTRU performs and/or reports measurements associated with the deactivated TCI at a different rate (e.g., a longer periodicity) and/or with one or more different parameters compared with measurements performed and/or reported when the TCI state is not deactivated; and/or, the WTRU stops, or ceases, a quasi co-location (QCL) tracking on the deactivated TCI, where the QCL tracking may imply measurement on an RS(s) associated with a TCI state (e.g., the deactivated TCI) and derivation or estimation of at least one channel or signal property of following: {Average delay, Delay spread, Doppler shift, Doppler spread, Spatial Rx parameter, Average power, etc.}.

In another case, a WTRU may apply, or determine to apply, one or more behaviors based on the deactivated TCI. For example, based on the deactivated DCI, the WTRU may apply, or determine to apply, a default RS(s), TCI(s), or QCL source in a second RS resource (e.g., CSI-RS, SRS) or channel (e.g., PDCCH, PDSCH, PUCCH, PUSCH), on a condition that a third TCI state associated with the second RS resource or channel is identified as the deactivated TCI.

The WTRU may transmit or receive, based on the default RS(s), TCI(s), or QCL source (e.g., instead of the third TCI state), a signal over the second RS resource or channel. The default RS(s), TCI(s), or QCL source may be pre-determined or configured based on at least one of following: an SSB index (e.g., which is used for (or associated with) the most recent PRACH transmission to a serving cell); a tracking RS (TRS) (e.g., with a pre-determined ID, such as a lowest-indexed TRS configured in a serving-cell); and/or, a pre-determined TCI state (e.g., which is associated with a CORESET, such as CORESET #0). Based on the determination of stopping the QCL tracking on the deactivated TCI, the WTRU may not expect to receive an indication associated with the RS(s) of the deactivated TCI to transmit an UL signal (or channel) and/or receive a DL signal (or channel). It may imply the base station needs to indicate other RS(s) instead of the RS(s) in scheduling a DL reception at the WTRU and/or a UL transmission from the WTRU.

For example, based on the deactivated DCI, the WTRU may maintain at least one (e.g., minimal) measurement and/or reporting behavior based on the deactivated TCI, such as a long-term (e.g., with separated configuration parameters, such as longer periodicity and/or separated layer-3 filtering equation based) RRM measurement and/or reporting (e.g., separated-event based reporting) based on the deactivated TCI.

In some cases, there may be UTCI deactivation based on a UTCI selection. A WTRU may currently use and/or apply {TCI3, TCI7} (e.g., as unified TCIs applicable for multiple channel(s)/signal(s)), for communication with a base station. The WTRU may receive DCI1 (e.g., DL-DCI) indicating {TCI3, TCI7}, which are the same ones as the currently used ones (e.g., via a TCI field of the DCI1), and scheduling PDSCH1 (e.g., data packet), which is transmitted k0 after the DCI1 is transmitted, where the value of k0 may be indicated in the same DCI1, or via a separate signaling.

In, or associated with, a DCI (e.g., the DCI1), the WTRU may receive a separate indication of selecting an UTCI (e.g., a first one of the {TCI3, TCI7}, such as TCI3) to be applied to at least one particular channel or signal (e.g., the PDSCH1). In response to determining that a UTCI selection (e.g., TCI3) among multiple UTCIs (e.g., {TCI3, TCI7}) that are currently available to be applied for multiple channels and/or signals (e.g., associated with the list of the multiple channel(s)/signal(s), such as configured by a higher-layer signaling), the WTRU may determine a second UTCI (e.g., TCI7, that is another (or other) UTCI(s) being not selected among the multiple UTCIs) which may be deactivated after a time offset (e.g., associated with receiving the UTCI selection).

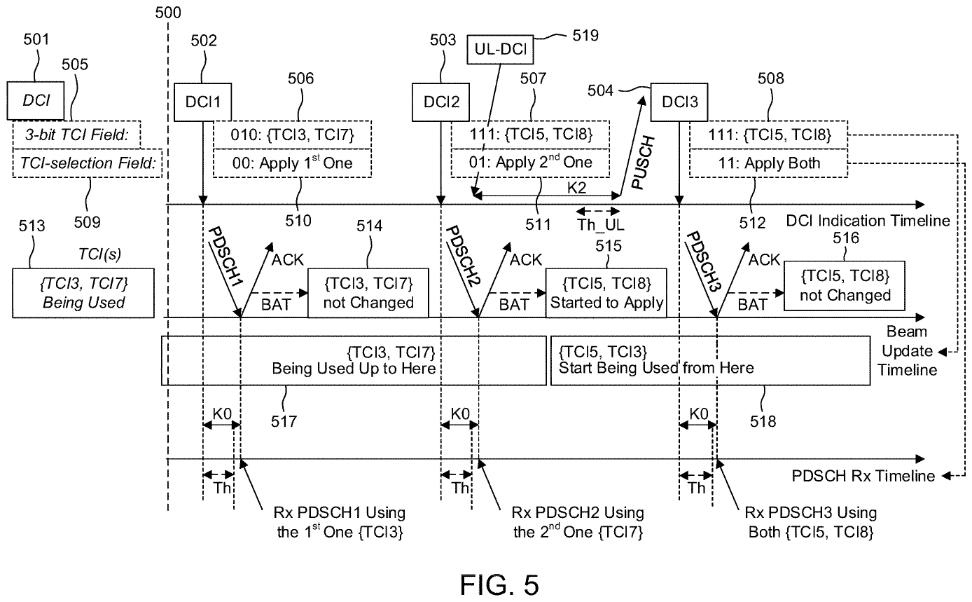

FIG. 5 illustrates an example of UTCI deactivation based on an UTCI selection. From this figure, it may be understood that for a given scenario a WTRU may have an initial of TCI state(s) (e.g., pre-configured, or configured from a DCI, such as 501, as described herein); a DCI may comprise a 3-bit TCI field 505; a DCI may also have a TCI-selection field 509. Prior to 500, a WTRU may currently use and/or apply {TCI3, TCI7} 513 (e.g., as unified TCIs applicable for multiple channel(s)/signal(s), for communication with a base station. After 500, the WTRU may receive DCI1 (e.g., DL-DCI) indicating {TCI3, TCI7} at 506, which are the same ones as the currently used ones (e.g., 513, via a TCI field of the DCI1), and scheduling PDSCH1 (e.g., data packet), which is transmitted k0 after the DCI1 is transmitted, where the value of k0 may be indicated in the same DCI1, or via a separate signaling.

In, or associated with, a DCI (e.g., the DCI1), the WTRU may receive a separate indication selecting an UTCI (e.g., a first one of the {TCI3, TCI7}, such as TCI3) to be applied to at least one particular channel or signal (e.g., the PDSCH1). In response to determining a UTCI selection (e.g., TCI3) among multiple UTCIs (e.g., {TCI3, TCI7}) that are currently available to be applied for multiple channels and/or signals (e.g., associated with the list of the multiple channel(s)/signal(s), such as configured by a higher-layer signaling), the WTRU may determine a second UTCI (e.g., TCI7, that is another (or other) UTCI(s) being not selected among the multiple UTCIs) which may be deactivated after a time offset (e.g., associated with receiving the UTCI selection). Said another way, as may be understood from the illustrations of FIG. 4, the WTRU may apply a first TCI based on the indication received at 510, then the WTRU may be able to determine to deactivate a second TCI.

In an example, the time offset that may be sent in a configuration message or indicated to the WTRU (e.g., from a base station), may be based on (e.g., determined with respect to, or associated with) at least one of following: reception timing of the DCI (e.g., the DCI1); reception timing of the separate indication of selecting the UTCI (e.g., based on the TCI selection field); and/or, transmission timing of an ACK in response to receiving the DCI.

The deactivation of the second UTCI (e.g., TCI7, which may be different from the selected one {TCI3}) may imply (e.g., trigger, cause, result in, etc.) one or more actions.

In an example, the deactivation of the second UTCI may imply that the WTRU may cease or stop a quasi co-location (QCL) tracking on the second TCI, which provides benefits to reduce WTRU complexity. The QCL tracking may imply measurement on an RS(s) associated with the second TCI and derivation or estimation of at least one channel or signal property of following: {Average delay, Delay spread, Doppler shift, Doppler spread, Spatial Rx parameter, Average power, etc.}. The WTRU may not expect to receive an indication associated with the RS(s) of the second TCI to transmit an UL signal (or channel) and/or receive a DL signal (or channel). It may imply the base station needs to indicate other RS(s) instead of the RS(s) in scheduling a DL reception at the WTRU and/or a UL transmission from the WTRU. If the WTRU receives an indication associated with the RS(s) of the second TCI (e.g., after the time duration passed or elapsed, to transmit an UL signal (or channel) and/or receive a DL signal (or channel)), the WTRU may apply a default TCI or beam or third RS(s) other than the RS(s), to transmit the UL signal (or channel) and/or receive a DL signal (or channel). If the WTRU receives an indication associated with the RS(s) of the second TCI (e.g., after the time duration passed or elapsed, to transmit an UL signal (or channel) and/or receive a DL signal (or channel)), the WTRU may send (back) a negative ACK (NACK) message informing the base station of the current status, such as where the message indicates that the WTRU has deactivated the second TCI.

In an example, the deactivation of the second UTCI may imply that the WTRU may not include (e.g., may exclude) the RS(s) of the second TCI in a CSI or beam or mobility measurement resource(s) associated with a CSI or beam or mobility-related reporting procedure. It may imply that the WTRU may cease or stop measuring the RS(s) of the second TCI for the purpose of the CSI, beam, and/or mobility measurement and reporting, and the WTRU may remove the RS(s) from the configured list of RSs in the corresponding measurement resource. The base station may need to reconfigure the measurement resource if the base station intends to include the RS(s) later into the list.

In an example, the deactivation of the second UTCI may imply that the WTRU may maintain at least one (e.g., minimal) measurement behavior and/or reporting behavior, such as (one or more): a (minimal) RRM measurement/reporting based on the second TCI, which may comprise a long-term (e.g., a particularly configured or indicated layer-3 filtering based) measurement and an event-based reporting; a (minimal) radio link monitoring (RLM)-related and/or radio link failure (RLF)-related measurement/reporting based on the second TCI, which may comprise a separated RLM-checking condition on a deactivated TCI (e.g., the second TCI) to be checked for RLF with lower priority (compared with other RS(s) configured or associated with the RLM or RLF procedure); a (minimal) beam failure recovery (BFR)-related measurement/reporting based on the second TCI, which may comprise a separated BFR-checking condition on a deactivated TCI (e.g., the second TCI) to be checked for BFR with lower priority (compared with other RS(s) configured or associated with the BFR procedure); and/or, the like (e.g., as described herein).

In some situations, there may be one or more conditions to determine that a second TCI (UTCI) is to be activated. It may be assumed (e.g., for the purposes of explaining an example, but not intended to limit) for such situations that the WTRU received, before a certain amount of time, an indication of one or more TCI states (e.g., UTCIs) (e.g., via a TCI field in a DL-DCI), which are assumed to be used as UTCIs currently (e.g., at a time of receiving a DCI (discussed herein)).

One condition that may be used to determine the second TCI (UTCI) is to be deactivated may be based on a codepoint of a DCI field in a DCI, where the codepoint may explicitly indicate which TCI(s) to be deactivated, such as among the one or more TCI states. For example, the codepoint may directly indicate the second TCI to be deactivated. For example, the codepoint may indicate the TCI to be used for DL/UL communication, and the WTRU may determine the second TCI that is other than the TCI among the one or more TCI states.

One condition that may be used to determine the second TCI (UTCI) is to be deactivated may be based on a codepoint of a DCI field in a DCI, where the codepoint may indicate to apply whichever the most recent selected/used TCI, before receiving the DCI, and determine a second TCI that is other than the TCI among the one or more TCI states, and deactivate the second TCI.

For example, for the DCI field (e.g., 2-bit): ‘00’ may apply/select the 1st one of the one or more TCI states; ‘01’ may apply/select the 2nd one of the one or more TCI states; ‘10’ may apply/select both (or all) of the one or more TCI states; ‘11’ (the codepoint, such as in a UL-DCI) may apply whichever the most recent selected/used TCI, before receiving the DCI, determine a second TCI which is other than the TCI among the one or more TCI states, and deactivate the second TCI. For instance, if the previous indication was ‘00’ as selecting 1st TCI, then, keep using the 1st TCI (for communication with TRP1) and deactivate the 2nd TCI (no more QCL tracking with the 2nd TCI) which may mean to fall back to sTRP (TRP1). This may be beneficial because it reduces WTRU-complexity for QCL tracking. The deactivated TCI may be not only for the PUSCH but also deactivated for other channel(s)/signal(s) (e.g., PDCCH, PDSCH, and/or PUCCH, etc., (e.g., based on base station's configuration/indication).

For example, for the codepoint in a DL-DCI, adding a condition that the one or more TCI states are not changed by a second DCI field (e.g., ‘TCI field’) in the same DL-DCI (compared with a previous indication by a ‘TCI field’). For ‘11’ (the codepoint, such as in a DL-DCI), it may apply whichever the most recent selected/used TCI, before receiving the DCI, determine a second TCI which is other than the TCI among the one or more TCI states, and deactivate the second TCI when the one or more TCI states indicated by a TCI field in the same DL-DCI are not changed (from the most recent indication by a TCI field). For instance, if the previous indication was ‘00’ as selecting 1st TCI, then, keep using the 1st TCI (for communication with TRP1) and deactivate the 2nd TCI (no more QCL tracking with the 2nd TCI), when the one or more TCI states indicated by a TCI field in the same DL-DCI are not changed (from the most recent indication by TCI field), which may mean to fallback to sTRP (TRP1). This may be beneficial because it reduces WTRU-complexity for QCL tracking. The deactivated one may be not only for the PDSCH but also deactivated for other channel(s)/signal(s) (e.g., PDCCH, PUSCH, and/or PUCCH, etc., (based on base station's configuration/indication).

In some situations, there may be behaviors on other channel(s)/signal(s) with deactivated UTCI. For PDCCH, and/or SPS-PDSCH, reception when the corresponding UTCI is deactivated by the UTCI-selector field, the WTRU may apply at least one of following: that CORESET and PDCCH monitoring, and/or SPS-PDSCH Rx, is ceased/stopped; and/or, that CORESET and PDCCH monitoring, and/or SPS-PDSCH Rx, is continued with the non-deactivated one (e.g., beam switching, such as sTRP fallback, such as where it would always fallback to a primary TRP). For PUCCH, or CG-PUSCH or SRS or PRACH, transmission when the corresponding UTCI is deactivated by the UTCI-selector field, apply at least one of following: that PUCCH (e.g., of a PUCCH resource group), CG-PUSCH, SRS, and/or PRACH Tx is ceased; and/or, that PUCCH (e.g., of a PUCCH resource group), CG-PUSCH, SRS, and/or PRACH Tx is continued with the non-deactivated one (e.g., beam switching, such as sTRP fallback, such as where it would always fallback to a primary TRP).

In some cases, there may be cross-carrier scheduling based on a multi-stage UTCI management framework. In one case, a WTRU may receive configuration information indicating a plurality of TCI states. The WTRU may receive, in CC1, a first indication of first one or more TCI states of the plurality of TCI states (e.g., via a TCI field in a first DCI) (e.g., DL-DCI which schedules PDSCH1), where the WTRU starts to use (e.g., at least in CC1 (e.g., as default) the first one or more TCI states at time T1. The WTRU may receive, in CC2, a second indication of second one or more TCI states of the plurality of TCI states (e.g., via a TCI field in a second DCI) (e.g., DL-DCI which schedules PDSCH2), where the WTRU starts to use (e.g., at least in CC2 (e.g., as default)) the second one or more TCI states at time T2.

At least after the T1 and/or T2, the WTRU may receive in CC1 a third DCI (e.g., DL-DCI), using at least one of the first one or more TCI states, where the third DCI: schedules PDSCH3 to be transmitted in CC2 (e.g., based on a carrier indicator; e.g., by a carrier indicator field; CIF) in the third DCI as a cross-carrier scheduling; and/or, selects a TCI state (e.g., by a TCI-selection field of the third DCI) among either the first one or more TCI states or the second one or more TCI states, based on a CC-determination rule which may be explicitly configured by a base station and/or implicitly determined based on a rule or condition.

The CC-determination rule may be at least one or more of the following examples, where the rule to use may be configured: example rule 1 (to follow “scheduling CC”), where the WTRU receives the PDSCH3 in CC2 using the selected TCI state (e.g., indicated by the TCI-selection field of the third DCI) from among the first one or more TCI states indicated by the first DCI received in CC1; example rule 2 (to follow “scheduled CC”), where the WTRU receives the PDSCH3 in CC2 using the selected TCI state (e.g., indicated by the TCI-selection field of the third DCI) from among the second one or more TCI states indicated by the second DCI received in CC2; and/or, example rule 3 (to follow “a TCI-reference CC”), where the WTRU receives the PDSCH3 in CC2 using the selected state TCI (e.g., indicated by the TCI-selection field of the third DCI) from among fourth one or more TCI states indicated by a fourth DCI received in a TCI-reference CC (e.g., CC3), where the TCI-reference CC may be sent in a configuration message (e.g., by the base station) and/or determined by the WTRU (e.g., a lowest indexed CC configured for the WTRU).

A WTRU may report one or more WTRU capability parameters associated with carrier aggregation (CA) functionality, such as maximum number of supported component carriers (CCs), maximum number of supported primary cells (e.g., for supporting dual connectivity), supported band combination(s), whether a unified TCI framework is supported per CC (or CC group), and/or whether multi-TRP (mTRP) operation is supported per CC (or CC group), etc.

The WTRU may receive (e.g., on a condition that the reported one or more WTRU capability parameters comprised support of the unified TCI framework for a CC (or CC group)), a configuration of a plurality of transmission configuration indicator (TCI) states in the CC (e.g., unified TCI (UTCI) states), each applicable for multiple channel(s) or signal(s) in the CC and/or a second CC(s). The multiple channel(s) or signal(s), associated with a TCI state, may be sent in a configuration message to the WTRU, or pre-determined or defined (e.g., in the form of a list applicable for at least one CC, by a higher-layer signaling (e.g., RRC and/or MAC-CE)).

The WTRU may receive, in CC1, a first indication of first one or more TCI states (e.g., via a TCI field in a first DCI) (e.g., DL-DCI which schedules PDSCH1), of the plurality of TCI states, where the WTRU may start to use (e.g., at least in CC1 (as e.g. default)) the first one or more TCI states at time T1. The time T1 may be determined based on at least one of a reception timing of the first DCI, a reception timing of PDSCH1, an ACK transmission timing in response to receiving the PDSCH1, and a beam application time (BAT) parameter (e.g., configured from the base station and/or reported by the WTRU as a part of WTRU capability parameters).

The WTRU may receive, in CC2, a second indication of second one or more TCI states (e.g., via a TCI field in a second DCI) (e.g., DL-DCI which schedules PDSCH2), of the plurality of TCI states, where the WTRU starts to use (e.g., at least in CC2 (as default) the second one or more TCI states at time T2. The time T2 may be determined based on at least one of a reception timing of the second DCI, a reception timing of PDSCH2, an ACK transmission timing in response to receiving the PDSCH2, and a BAT parameter (e.g., configured from the base station and/or reported by the WTRU as a part of WTRU capability parameters).

In one case, there may be cross-carrier scheduling by a DL-DCI. At least after a T1 and/or T2 (e.g., relative to another example herein), the WTRU may receive in CC1 a third DCI (e.g., DL-DCI), using at least one of the first one or more TCI states, where the third DCI indicates, informs, and/or enables the WTRU to perform an action, the third DCI comprising one or more of the following: schedules PDSCH3 to be transmitted in CC2, such as based on a carrier indicator (e.g., by a carrier indicator field; CIF) in the third DCI as a cross-carrier scheduling; selects a TCI (e.g., by a TCI-selection field of the third DCI) among either the first one or more TCI states or the second one or more TCI states, based on a CC-determination rule that may be explicitly configured by a base station and/or implicitly determined based on a rule or condition; and/or indicates third one or more TCI states (e.g., via the TCI field in the third DCI), of the plurality of TCI states, where the WTRU starts to use the third one or more TCI states at time T3.

The CC-determination rule may be comprised of at least one or more rules. In one example, a rule 1 (to follow “scheduling CC”) may indicate to select a TCI (e.g., by a TCI-selection field of a DCI) in a CC that the DCI is transmitted on. On a condition that the WTRU applies (e.g., determines to apply) rule 1, the WTRU may receive the PDSCH3 in CC2 using a selected TCI (e.g., by a TCI-selection field of the third DCI) among the first one or more TCI states being indicated by the first DCI in CC1. This may correspond to a cross beam, or TCI, indication case or mode. The CC1 may be (e.g., be configured as) a reference, or special, CC that unified TCIs are configured and/or coming from (e.g., to be applied to the same CC and/or other CC(s)). The WTRU may apply this rule 1 on condition of an intra-band CC case, where the intra-band CC case may mean that the CC1 and CC2 are in (e.g., within) an intra-band CC combination (e.g., being configured to the WTRU). In one instance, applying the intra-band CC condition may be because, in the intra-band CC case, the CC1 and the CC2 may not be located too far away each other in a frequency domain, so that the selected TCI from the CC1 may be applicable in the CC2 (e.g., as the cross-beam indication; e.g., without loss of performance in terms of beam mismatch). This may provide benefits in that the rule 1 may not need to be explicitly configured to the WTRU.

In another example, a rule 2 (to follow “scheduled CC”), may indicate to select a TCI (e.g., by a TCI-selection field of a DCI) in a CC that a PDSCH (e.g., scheduled by the DCI) is transmitted on (e.g., when the CIF indicates a cross-carrier scheduling). On a condition that the WTRU applies (e.g., determines to apply) rule 2, the WTRU may receive the PDSCH3 using a selected TCI (e.g., by a TCI-selection field of the third DCI) among the second one or more TCI states being indicated by the second DCI in CC2. The WTRU may apply this rule 2 on condition of an inter-band CC case, where the inter-band CC case may mean that the CC1 and CC2 are in an inter-band CC combination (e.g., being configured to the WTRU). For instance, applying the inter-band CC condition may be because, in the inter-band CC case, the CC1 and the CC2 may be located far away each other in a frequency domain, so that the selected TCI from the CC2 (e.g., not from the CC1) to be applicable in the CC2 may provide robustness in beam, or TCI, management. This may provide benefits in that the rule 2 may not need to be explicitly configured to the WTRU.

In yet another example, a rule 3 (to follow “a TCI-reference CC”), may indicate to select a TCI (e.g., by a TCI-selection field of a DCI) in a CC that is explicitly configured as a TCI-reference CC, or implicitly determined for the TCI-reference CC to be a pre-defined or pre-determined CC (e.g., a lowest indexed CC configured for the WTRU). On a condition that the WTRU applies (e.g., determines to apply) rule 3, the WTRU may receive the PDSCH3 using a selected TCI (e.g., by a TCI-selection field of the third DCI) among fourth one or more TCI states being indicated (e.g., via a TCI field of a DCI, in the TCI-reference CC (e.g., CC3).

In one case, there may be cross-carrier scheduling by a UL-DCI. At least after the T1 and/or T2, the WTRU may receive in CC1 a fourth DCI (e.g., UL-DCI), using at least one of the first one or more TCI states, where the fourth DCI indicates, informs, and/or enables the WTRU to perform an action, the third DCI comprising one or more of the following: schedules a PUSCH to be transmitted in CC (e.g., based on a carrier indicator (e.g., by a CIF)) in the fourth DCI as a cross-carrier scheduling; and/or selects a TCI (e.g., by a UL-TCI-selection field or one or more of existing DCI fields of the fourth DCI) among either the first one or more TCI states or the second one or more TCI states, based on the CC-determination rule.

On a condition that the WTRU applies (e.g., determines to apply) rule 1 (to follow “scheduling CC”), the WTRU may transmit the scheduled PUSCH in CC2 using a selected TCI (e.g., by the UL-TCI-selection field or one or more of existing DCI fields of the fourth DCI) among the first one or more TCI states being indicated by the first DCI in CC1. This may correspond to a cross beam, or TCI, indication case or mode. The CC1 may be (e.g., be configured as) a reference, or special, CC that unified TCIs are configured and/or coming from (e.g., to be applied to the same CC and/or other CC(s)).

On a condition that the WTRU applies (e.g., determines to apply) rule 2 (to follow “scheduled CC”), the WTRU may transmit the scheduled PUSCH in CC2 using a selected TCI (e.g., by the UL-TCI-selection field or one or more of existing DCI fields of the fourth DCI) among the second one or more TCI states being indicated by the second DCI in CC2.

On a condition that the WTRU applies (e.g., determines to apply) rule 3 (to follow “a TCI-reference CC”), the WTRU may transmit the scheduled PUSCH in CC2 using a selected TCI (e.g., by the UL-TCI-selection field or one or more of existing DCI fields of the fourth DCI) among the fourth one or more TCI states being indicated (e.g., via a TCI field of a DCI, in the TCI-reference CC (e.g., CC3).

In an example, a PDSCH default beam may be determined based on UTCI selector in a DL-DCI. A WTRU may receive configuration of a plurality of transmission configuration indicator (TCI) states, such as unified TCI (UTCI) states, each applicable for multiple channel(s) or signal(s). The multiple channel(s) or signal(s), associated with a TCI state, may be sent in a configuration message to the WTRU, or pre-determined or defined, such as in a form of a list, by a higher-layer signaling (e.g., RRC and/or MAC-CE).

The WTRU may receive DCI1, where the DCI1 indicates {TCI1, TCI2} via a first field (e.g., TCI field) of the DCI1 and schedules PDSCH1. The WTRU may transmit a first ACK in response to receiving (e.g., successfully receiving) DCI1 and/or PDSCH1.

The WTRU may receive (e.g., after transmitting the first ACK) DCI2 using at least one of {TCI1, TCI2}, where the DCI2 indicates {TCI3, TCI4} via the first field (e.g., TCI field) of the DCI2 and schedules PDSCH2. The DCI2 may further indicate a selector via a second field (e.g., TCI-selection field), where the selector indicates one of the TCI states {TCI1, TCI2} that were indicated by the DCI1.

The WTRU may receive PDSCH2 using a TCI state determined based on at least one of: the selector indicated by DCI2, a time offset k0 between the transmission (or reception) of DCI2 and the transmission (or reception) of PDSCH2, a default TCI state, and/or a previously indicated TCI state. In an example, the value of k0 is indicated in DCI2. In an example, if the value of k0 is less than a threshold, the WTRU uses a default TCI state, TCI X, to receive PDSCH2. In an example, if the value of k0 is greater than the threshold, the WTRU uses the TCI state indicated by the selector to receive PDSCH2. In an example, the threshold is a part of WTRU capability parameters (e.g., that are reported to the gNB).

The WTRU may transmit a second ACK in response to receiving (e.g., successfully receiving) DCI2 and/or PDSCH2. In an example, the WTRU uses TCI3 or TCI4 for receiving another PDSCH or PDCCH after receiving PDSCH2.

In some situations, there may be a default TCI state. In an example, the default TCI X may be, or may be determined based on one or more factors, such as a previously selected TCI state (e.g., a most recently selected TCI state) by a TCI-selection field in a DCI3 (e.g., scheduling a PDSCH3) received prior to DCI2 that satisfies the condition that the WTRU sent an ACK for DCI3 or PDSCH3 (e.g., indicating successful reception of DCI3 or PDSCH3) at least a time duration (e.g., configured time duration) before the transmission (or reception) of DCI2. The time duration may be determined based on a beam application time (BAT) parameter configured from the base station and/or reported by the WTRU as a part of WTRU capability parameters. Additionally/alternatively, the default TCI X may be, or may be determined based on a default UTCI state, which may be TCI Y, associated with a CORESET with a pre-defined or pre-configured CORESET index, such as UTCI(s) associated with a CORESET with a lowest, or highest, ID.

In an example, one or more UL beam(s) may be determined based on the timing of certain received indications/messages/configurations and/or based on a UTCI selector in a UL-DCI. A WTRU may receive configuration of a plurality of transmission configuration indicator (TCI) states (e.g., unified TCI (UTCI) states) each applicable for multiple channel(s) or signal(s). The multiple channel(s) or signal(s), associated with a TCI state, may be sent in a configuration message to the WTRU (or pre-determined or defined), such as in a form of a list, by a higher-layer signaling (e.g., RRC and/or MAC-CE).

The WTRU may receive a first indication of a first one or more TCI states (e.g., via a TCI field in a first DCI (e.g., DL-DCI which may schedule PDSCH1), of the plurality of TCI states), where the WTRU starts to use the first one or more TCI states at time T1. The time T1 may be determined based on at least one of a reception timing of the first DCI, a reception timing of PDSCH1, an ACK transmission timing in response to receiving the PDSCH1, and/or a beam application time (BAT) parameter (e.g., configured from the base station and/or reported by the WTRU as a part of WTRU capability parameters).

After the first indication, the WTRU may receive a second indication of a second one or more TCI states (e.g., via the TCI field in a second DCI (e.g., DL-DCI which may schedule PDSCH2), of the plurality of TCI states, where the WTRU starts to use the second one or more TCI states at time T2. The time T2 may be determined based on at least one of a reception timing of the second DCI, a reception timing of PDSCH2, an ACK transmission timing in response to receiving the PDSCH2, and/or the BAT parameter.

The WTRU may receive a UL-DCI scheduling a PUSCH and selecting a TCI, among either the first one or more TCI states or the second one or more TCI states, to be applied for transmission of the scheduled PUSCH. The UL-DCI may comprise a UL-TCI-selection field or one or more of existing DCI fields selecting the TCI.

The WTRU may determine to apply either the first one or more TCI states or the second one or more TCI states, based on at least one of: the relationship between T1 and T2 (e.g., whether T1<T2); when the WTRU receives the UL-DCI with respect to T1 and T2 (e.g., whether reception is between T1 and T2 or after T2); and/or, when the WTRU transmits or is scheduled to transmit the PUSCH (e.g., whether the transmission is or is scheduled to be between T1 and T2 or after T2).

The WTRU may transmit the PUSCH using the first one or more TCI states or the second one or more TCI states based on the determination.

In one example scenario, a WTRU may apply (or determine to apply) the first one or more TCI states or the second one or more TCI states, based on which is most recently (e.g., started to be) used before receiving the UL-DCI. In one instance, the WTRU may select a TCI among the second one or more TCI states being indicated by the second DCI, on a condition that T1<T2 and the WTRU receives the UL-DCI after T2. In another instance, the WTRU may select a TCI among the first one or more TCI states being indicated by the first DCI, on a condition that T1<T2 and the WTRU receives the UL-DCI after T1 and before T2.

In one example situation, a WTRU may apply (or determine to apply) the first one or more TCI states or the second one or more TCI states based on which is the most recently (e.g., started to be) used before transmitting the PUSCH scheduled by the UL-DCI. In one instance, the WTRU selects a TCI among the second one or more TCI states being indicated by the second DCI, on a condition that T1<T2 and the WTRU transmits the PUSCH after T2. In another instance, the WTRU may select a TCI among the first one or more TCI states being indicated by the first DCI, on a condition that T1<T2 and the WTRU transmits the PUSCH after T1 and before T2.

In one example scenario, WTRU may apply (or determine to apply) the first one or more TCI states or the second one or more TCI states based on which is most recently (e.g., started to be) used at least a time offset before transmitting the PUSCH scheduled by the UL-DCI, where the time offset may be configured from the base station and/or reported by the WTRU as a part of WTRU capability parameters. In one instance, the WTRU may select a TCI among the second one or more TCI states being indicated by the second DCI, on a condition that T1<T2 and the WTRU transmits the PUSCH after T2 plus the time offset. In one instance, the WTRU may select a TCI among the first one or more TCI states being indicated by the first DCI, on a condition that T1<T2 and the WTRU transmits the PUSCH after T1 plus the time offset and before T2 plus the time offset.

In an example, there may be a UTCI deactivation mechanism in a multi-stage UTCI management framework. A WTRU may receive a configuration of a plurality of transmission configuration indicator (TCI) states (e.g., unified TCI (UTCI) states), each applicable for multiple channel(s) or signal(s). The multiple channel(s) or signal(s), associated with a TCI state, may be sent in a configuration message to the WTRU, or pre-determined or defined, such as in a form of a list, by a higher-layer signaling (e.g., RRC and/or MAC-CE).

The WTRU may receive DCI1, where the DCI1 indicates {TCI1, TCI2} via a first field (e.g., TCI field) of the DCI1 and schedules PDSCH1. The WTRU may transmit a first ACK in response to receiving (e.g., successfully receiving) DCI1 and/or PDSCH1.

The WTRU may receive (e.g., after transmitting the first ACK) DCI2 using at least one of {TCI1, TCI2}, where the DCI2 indicates {TCI3, TCI4} via the first field (e.g., TCI field) of the DCI2 and schedules PDSCH2. The DCI2 may further indicate a selector via a second field (e.g., TCI-selection field), where the selector indicates one of the TCI states {TCI1, TCI2} that were indicated by the DCI1.

In response to receiving the DCI2, the WTRU may determine that a TCI state different from the TCI state selected by the selector is a deactivated TCI state after a time offset (e.g., the WTRU may be configured (e.g., RRC signaling, etc.) to perform a deactivation based on a mode/operation). The time offset may be determined based on at least one of a reception timing of the DCI2, a reception timing of PDSCH2, an ACK transmission timing in response to receiving the PDSCH2, and/or a beam application time (BAT) parameter (e.g., configured from the base station and/or reported by the WTRU as a part of WTRU capability parameters). For instance, if the selector indicates TCI1, then the WTRU determines TCI2 is a deactivated TCI after the time offset.

The WTRU may apply (or determines to apply) one or more behaviors based on the deactivated TCI, such as the WTRU performs and/or reports measurements: associated with the deactivated TCI at a different rate (e.g., a longer periodicity); associated with one or more different parameters compared with measurements performed; and/or reported when the TCI state is not deactivated (e.g., reported before the time offset). The WTRU may apply (or determines to apply) one or more behaviors based on the deactivated TCI, such as the WTRU stops, or ceases, a quasi co-location (QCL) tracking (e.g., after the time offset) on the deactivated TCI, where the QCL tracking may imply measurement on an RS(s) associated with a TCI state (e.g., the deactivated TCI) and derivation or estimation of at least one channel or signal property (e.g., Average delay, Delay spread, Doppler shift, Doppler spread, Spatial Rx parameter, Average power, etc.).

In an example, there may be cross-carrier scheduling based on a multi-stage UTCI management framework. A WTRU may receive configuration information indicating a plurality of TCI states.

The WTRU may receive, in CC1, a first indication of first one or more TCI states of the plurality of TCI states, (e.g., via a TCI field in a first DCI (e.g., DL-DCI which schedules PDSCH1), where the WTRU starts to use (e.g., at least in CC1 (e.g., as default) the first one or more TCI states at time T1.

The WTRU may receive, in CC2, a second indication of second one or more TCI states of the plurality of TCI states (e.g., via a TCI field in a second DCI (e.g., DL-DCI which schedules PDSCH2)), where the WTRU starts to use (e.g., at least in CC2 (e.g., as default)) the second one or more TCI states at time T2.

At least after the T1 and/or T2, the WTRU may receive in CC1 a third DCI (e.g., DL-DCI), using at least one of the first one or more TCI states. The third DCI may provide one or more actions, which may trigger one or more actions. Third DCI may schedule PDSCH3 to be transmitted in CC2 (e.g., based on a carrier indicator (e.g., by a carrier indicator field; CIF) in the third DCI as a cross-carrier scheduling). Additionally/alternatively, the third DCI may select a TCI state (e.g., by a TCI-selection field of the third DCI) among either the first one or more TCI states or the second one or more TCI states, based on a CC-determination rule that may be explicitly configured by a base station and/or implicitly determined based on a rule or condition.

There may be one or more CC-determination rules, where the rule to use may be configured. For instance, first rule (to follow “scheduling CC”) may be where the WTRU receives the PDSCH3 in CC2 using the selected TCI state (e.g., indicated by the TCI-selection field of the third DCI) from among the first one or more TCI states indicated by the first DCI received in CC1.

For instance, a second rule (to follow “scheduled CC”) may be where the WTRU receives the PDSCH3 in CC2 using the selected TCI state (e.g., indicated by the TCI-selection field of the third DCI) from among the second one or more TCI states indicated by the second DCI received in CC2.

For instance, a third rule (to follow “a TCI-reference CC”) may be the WTRU receives the PDSCH3 in CC2 using the selected state TCI (e.g., indicated by the TCI-selection field of the third DCI) from among fourth one or more TCI states indicated by a fourth DCI received in a TCI-reference CC (e.g., CC3), where the TCI-reference CC may be sent in a configuration message (e.g., by the base station) and/or determined by the WTRU (e.g., a lowest indexed CC configured for the WTRU).

Of note regarding the above rules, for the first rule, it follows to scheduling CC (e.g., a CC where a DCI scheduling a PDSCH is transmitted, which is CC1) (e.g., where the first one or more TCIs matter). For the second rule, it follows to scheduled CC (e.g., a CC where the PDSCH, scheduled by the DCI, is transmitted, which is CC2) (e.g., where the second one or more TCIs matter).

In an example, a device may determine a PDSCH default beam based on a previously selected TCI state (e.g., a most recently selected TCI state) by a TCI-selection field in a DCI3 (e.g., scheduling a PDSCH3) received prior to DCI2 that satisfies the condition that the WTRU sent an ACK for DCI3 or PDSCH3 (e.g., indicating successful reception of DCI3 or PDSCH3) at least a time duration (e.g., configured time duration) before the transmission (or reception) of DCI2.

In an example, a UL-beam determination timeline may be based on a UTCI selector. For instance, a WTRU may apply, or determine to apply, the first one or more TCI states or the second one or more TCI states based on which is the most recently started to be used at least a time offset before transmitting the PUSCH scheduled by the UL-DCI.

In an example, there may be a UTCI deactivation mechanism, where a WTRU determines that a TCI state different from the TCI state selected by the selector is a deactivated TCI state. The WTRU may perform and/or report measurements associated with the deactivated TCI at a different rate (e.g., a longer periodicity) and/or with one or more different parameters compared with measurements performed and/or reported when the TCI state is not deactivated.

In an example, there may be cross-carrier scheduling based on a UTCI selector: In one instance, to follow “scheduling CC”, the WTRU receives the PDSCH3 in CC2 using the selected TCI state (e.g., indicated by the TCI-selection field of the third DCI) from among the first one or more TCI states indicated by the first DCI received in CC1. In another instance, to follow “scheduled CC”, the WTRU receives the PDSCH3 in CC2 using the selected TCI state (e.g., indicated by the TCI-selection field of the third DCI) from among the second one or more TCI states indicated by the second DCI received in CC2.

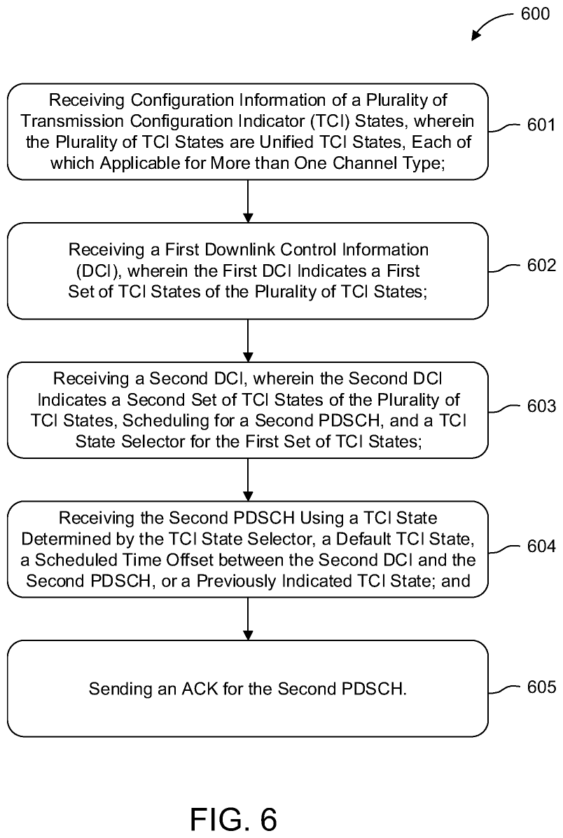

FIG. 6 illustrates an example method according to one or more techniques described herein. In this example, a PDSCH default beam may be determined based on one of indicated TCI states in a previous DCI. At 601, a WTRU may receive configuration of a plurality of transmission configuration indicator (TCI) states, such as unified TCI (UTCI) states, each applicable for multiple channel(s) or signal(s). The multiple channel(s) or signal(s), associated with a TCI state, may be sent in a configuration message to the WTRU, or pre-determined or defined, such as in a form of a list, by a higher-layer signaling (e.g., RRC and/or MAC-CE).

At 602, the WTRU may receive DCI1, where the DCI1 indicates {TCI1, TCI2} via a first field (e.g., TCI field) of the DCI1 and schedules PDSCH1. The WTRU may transmit a first ACK in response to receiving (e.g., successfully receiving) DCI1 and/or PDSCH1.

At 603, the WTRU may receive (e.g., after transmitting the first ACK) DCI2 using at least one of {TCI1, TCI2}, where the DCI2 indicates {TCI3, TCI4} via the first field (e.g., TCI field) of the DCI2 and schedules PDSCH2. The DCI2 may further indicate a selector via a second field (e.g., TCI-selection field), where the selector indicates one of the TCI states {TCI1, TCI2} that were indicated by the DCI1.

At 604, the WTRU may receive PDSCH2 using a TCI state determined based on at least one of: the selector indicated by DCI2, a time offset k0 between the transmission (or reception) of DCI2 and the transmission (or reception) of PDSCH2, a default TCI state, and/or a previously indicated TCI state. In an example the value of k0 is indicated in DCI2. In an example, if the value of k0 is less than a threshold, the WTRU uses a default TCI state, TCI X, to receive PDSCH2. In an example, if the value of k0 is greater than the threshold, the WTRU uses the TCI state indicated by the selector to receive PDSCH2. In an example, the threshold is a part of WTRU capability parameters (e.g., that are reported to the base station).

At 605, the WTRU may transmit a second ACK in response to receiving (e.g., successfully receiving) DCI2 and/or PDSCH2. In an example, the WTRU uses TCI3 or TCI4 for receiving another PDSCH or PDCCH after receiving PDSCH2.

In some situations, there may be a default TCI state. In an example, the default TCI X may be, or may be determined based on one or more factors, such as a previously selected TCI state (e.g., a most recently selected TCI state) by a TCI-selection field in a DCI3 (e.g., scheduling a PDSCH3) received prior to DCI2 that satisfies the condition that the WTRU sent an ACK for DCI3 or PDSCH3 (e.g., indicating successful reception of DCI3 or PDSCH3) at least a time duration (e.g., configured time duration) before the transmission (or reception) of DCI2. The time duration may be determined based on a beam application time (BAT) parameter configured from the base station and/or reported by the WTRU as a part of WTRU capability parameters. Additionally/alternatively, the default TCI X may be, or may be determined based on a default UTCI state, which may be TCI Y, associated with a CORESET with a pre-defined or pre-configured CORESET index, such as UTCI(s) associated with a CORESET with a lowest, or highest, ID.

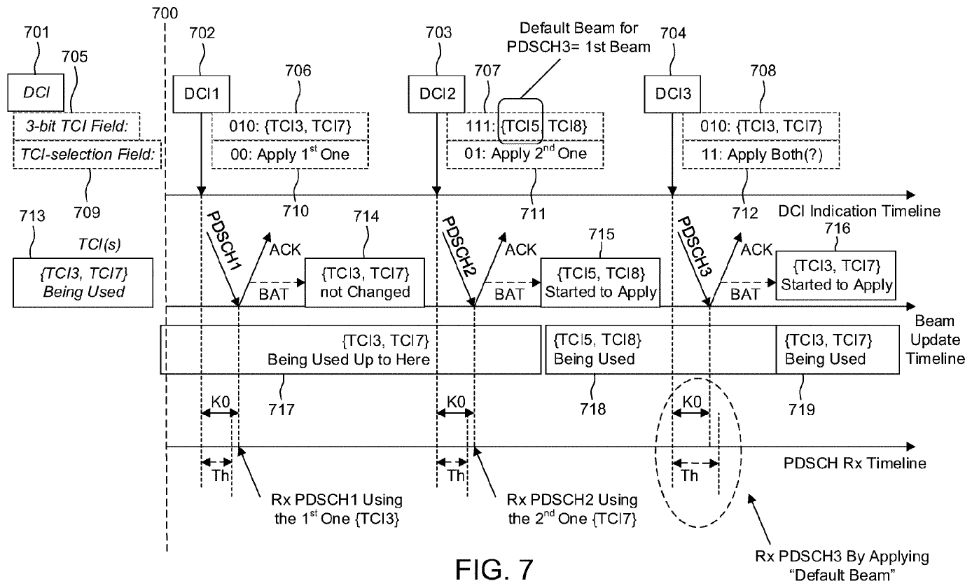

FIG. 7 illustrates an example of UTCI update timeline and UTCI selection. In this example, a WTRU may be in communication, or have established communication, with a base station prior to 700. For instance, at some point the WTRU may receive a DCI at 701. Generally, a DCI (e.g., at 701) may include a 3-bit TCI field 705; a DCI 701 may include a TCI selection field 709; a DCI 701 may include both a TCI field and a selection field. Prior to 700, the WTRU may have TCIs configured (e.g., TCI3 and TCI7, as shown at 713). At some point prior to 700, the WTRU may be configured with a list/index/set of TCI(s) (e.g., like those shown or similar to FIG. 2). After 700, the WTRU may receive DCI1 at 702. The DCI1 may include an ordered set of TCI states (e.g., of the plurality of TCIs received in the previously configured list/index). At 703, the WTRU may receive DCI2, which may include a second ordered set of TCI states (e.g., TCI5 and TCI8) that is different from the previous ordered set. The second ordered set of TCI-states may start to be applied after receiving PDSCH2 scheduled by the DCI2, sending an ACK for the PDSCH2, and after the BAT. At 704, the WTRU may receive DCI3 scheduling for PDSCH3. The DCI3 may also include a TCI selection field; in one instance, the TCI state indicated by the TCI selection field may indicate at least one TCI state that is different from a default TCI state. The WTRU may determine the default TCI state is the first-ordered TCI state (e.g., TCI5) of the second ordered set of TCI-states based on determining that the second ordered set has started to apply. The DCI3 may also include an indication of a time offset (e.g. k0, for the PDSCH3). The DCI3 may be received in a PDCCH transmission using at least one TCI state from the second ordered set of TCI states from DCI2. At some point after receiving DCI3, PDSCH3 may be received using the default TCI state. The WTRU may determine to receive the PDSCH3 based on the default TCI state and the time offset (e.g., k0) being less than a threshold; based on these one or more factors, the default TCI state may be determined to be the first TCI state indicated in the second ordered set of TCI states from DCI2.

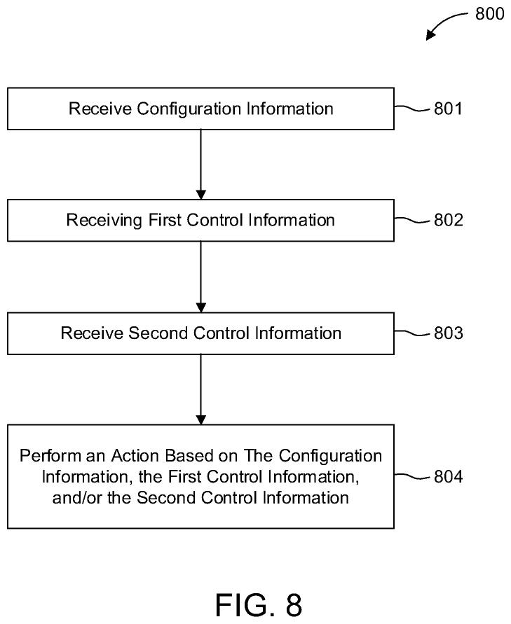

FIG. 8 illustrates an example of a TCI determination for use in sending/receiving. At 801, a WTRU may receive configuration information. At 802, the WTRU may receive first control information. At 803 the WTRU may receive second control information. At 804, the WTRU may perform an action based on one or more of the configuration information, the first control information, and/or the second control information. The action may include deactivating a TCI state, using one or more indicated TCI states, using a default TCI state (e.g., based on one or more other factors in combination with control information(s)), and/or another action disclosed herein.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-14. (canceled)

15. A method for use by a wireless transmit/receive unit (WTRU), the method comprising:
receiving configuration information that includes a plurality of transmission configuration indicator (TCI) states, wherein each of the plurality of TCI states is a unified TCI state and applicable for more than one channel type;
receiving a first downlink control information (DCI), wherein the first DCI indicates a first set of TCI states of the plurality of TCI states, wherein the first set of TCI states are associated with a first starting time;
receiving a second DCI, wherein the second DCI indicates a second set of TCI states of the plurality of TCI states, wherein the second set of TCI states is associated with a second starting time;
receiving an uplink (UL) grant; and
sending a physical uplink shared channel (PUSCH) transmission using one or more TCI states from either the first set of TCI states or the second set of TCI states, wherein the one or more TCI states are determined based on the UL grant, a configured relationship between the first starting time and the second starting time, or a relationship between the PUSCH is scheduled and the first starting time and the second starting time.

16. The method of claim 15, wherein the configuration information is from an RRC message or a MAC-CE.

17. The method of claim 15, wherein the first DCI and the second DCI include scheduling information for a downlink shared channel transmission.

18. The method of claim 15, wherein the first starting time and the second starting time are determined based on receiving a physical downlink shared channel, transmitting an acknowledgement, when the first DCI or the second DCI is received, or a configured beam application time parameter.

19. The method of claim 15, wherein the configured relationship between the first starting time and the second starting time is where the first starting time is before the second starting time.

20. The method of claim 15, wherein the relationship between when the PUSCH transmission is scheduled and the first starting time and the second starting time is where the PUSCH transmission is scheduled for a time that is between the first starting time and the second starting time, or the PUSCH transmission is scheduled for a time that is after the second starting time.

21. The method of claim 15, wherein the first DCI includes a TCI field that indicates the first set of TCI states.

22. A wireless transmit/receive unit (WTRU), the WTRU comprising:
a processor operatively coupled to a transceiver, the processor and transceiver configured to receive configuration information of a plurality of transmission configuration indicator (TCI) states, wherein the each of the plurality of TCI states is a unified TCI state and applicable for more than one channel type;
the processor and transceiver configured to receive a first downlink control information (DCI), wherein the first DCI indicates a first set of TCI states of the plurality of TCI states, wherein the first set of TCI states is associated with a first starting time;
the processor and transceiver configured to receive a second DCI, wherein the second DCI indicates a second set of TCI states of the plurality of TCI states, wherein the second set of TCI states is associated with a second starting time;
the processor and transceiver configured to receive an uplink (UL) grant; and
the processor and transceiver configured to send a physical uplink shared channel (PUSCH) transmission using one or more TCI states from either the first set of TCI states or the second set of TCI states, wherein the one or more TCI states are determined based on the UL grant, a configured relationship between the first starting time and the second starting time, or a relationship between the PUSCH is scheduled and the first starting time and the second starting time.

23. The WTRU of claim 22, wherein the configuration information is from an RRC message or a MAC-CE.

24. The WTRU of claim 22, wherein the first DCI and the second DCI include scheduling information for a downlink shared channel transmission.

25. The WTRU of claim 22, wherein the first starting time and the second starting time are determined based on receiving a physical downlink shared channel, transmitting an acknowledgement, when the first DCI or the second DCI is received, or a configured beam application time parameter.

26. The WTRU of claim 22, wherein the configured relationship between the first starting time and the second starting time is where the first starting time is before the second starting time.

27. The WTRU of claim 22, wherein the relationship between when the PUSCH transmission is scheduled and the first starting time and the second starting time is where the PUSCH transmission is scheduled for a time that is between the first starting time and the second starting time, or the PUSCH transmission is scheduled for a time that is after the second starting time.

28. The WTRU of claim 22, wherein the first DCI includes a TCI filed that indicates the first set of TCI states.
